(19) United States
(12) Patent Application Publication
(10) Pub. No.: US 2026/0004602 A1
(43) Pub. Date: Jan. 1, 2026

(54) PERSONALIZED DOCUMENT FIELD PREDICTION BASED ON LEARNING FROM USER FEEDBACK

(71) Applicant: Bill Operations, LLC, San Jose, CA (US)

(72) Inventors: Max STEPIN, San Jose, CA (US); Mohsen SARDARI, San Jose, CA (US); Gaurav TANDON, San Jose, CA (US); Changlin ZHANG, San Jose, CA (US); Nakul CHAKRAPANI, San Jose, CA (US)

(21) Appl. No.: 18/759,476

(22) Filed: Jun. 28, 2024

(51) Int. Cl. G06V 30/412; G06F 16/11; G06V 30/414

(52) U.S. Cl. CPC G06V 30/412; G06F 16/116; G06V 30/414

(57) ABSTRACT

Particular embodiments relate to personalized document field prediction based on user behavior and feature generation. Specifically, various embodiments have the technical effect of improved accuracy with respect to field/entity value prediction (e.g., predicting that the amount due is X via a Gradient Boosting Model) relative to document processing technologies by learning through user behavior data or feedback (e.g., through continuous reinforcement learning from human feedback (RLHF)). This is at least partially because of the technical solution of accessing or generating unique features from one or more documents previously used by a user.

### BACKGROUND

Existing document processing technologies use computerized models or other algorithms to process natural language characters in documents (e.g., invoices, letters, etc.). For example, some technologies can use standard natural language processing (NLP) models in order to determine the semantic meaning of words in a natural language sentence of a document by learning the common patterns across millions of users. However, these and related technologies fail to adequately extract information from documents, such as invoices or bills, especially when dealing with long-tail distributions of user behaviors. These existing technologies also unnecessarily consume computer resources (e.g., I/O, network latency, bandwidth), as described in more detail herein.

### BRIEF DESCRIPTION OF THE SEVERAL VIEWS OF THE DRAWINGS

The present technology is described in detail below with reference to the attached drawing figures, wherein:

FIG. 1 is a block diagram of an illustrative system architecture, according to some embodiments;

FIG. 2 is a block diagram of an example pipeline for extracting/predicting one or more values associated with one or more fields of a document, according to some embodiments;

FIG. 3 depicts a diagram of an example neural network trained to predict one or more values of one or more fields (e.g., in accounting software and/or at a document), according to some embodiments;

FIG. 4 is a block diagram of a Large Language Model that uses particular natural language input(s) to generate corresponding natural language output(s), according to some embodiments;

FIG. 5 is a screenshot of an example invoice illustrating how an invoice is parsed into four quadrants, which are used to extract features and obtain user behavior for future field predictions, according to some embodiments;

FIG. 6A is a screenshot of an example invoice illustrating a historical document from which embodiments generate features and extract user behavior in order to make predictions with respect to a current invoice of FIG. 6B, according to some embodiments;

FIG. 6B is a screenshot of an example invoice illustrating how a particular value is predicted based on features and user behavior data extracted for the invoice of FIG. 6A, according to some embodiments;

FIG. 7 is a schematic diagram of a table representing different extracted features, according to some embodiments;

FIG. 8 is a flow diagram of an example process for predicting one or more values of one or more fields associated with a document, according to some embodiments;

FIG. 9 is a block diagram of a computing environment in which aspects of the present technology are implemented within, according to some embodiments.

FIG. 10 is a block diagram of a computing device in which aspects of the present disclosure are implemented within, according to some embodiments.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

As described above, existing document processing technologies fail to adequately extract information from documents, such as invoices, bills, or other documents. Some of these technologies assist businesses in managing their bill payments, which involves computationally processing a large volume of invoices received from vendors or service providers. Invoices typically come in the form of image or PDF documents, which are unstructured data formats. This means that the information within the documents is not organized or labeled in a standardized manner.

To extract information from these unstructured documents, existing document processing technologies may perform optical character recognition (OCR) or other functionality. OCR is a function that converts scanned images or PDFs containing text into machine-readable text data. After OCR processing, the document is transformed into a structured format generally through spatial-embedding understanding such as template matching heuristics, CRF, NER and BERT based models. Some of these technologies may then extract/predict key field values such as the total amount due, minimum amount, due date, invoice date, and other relevant details. This structured format makes it easier to process and analyze the invoice data.

Some of these existing document processing technologies use machine learning models trained on a large dataset comprising various invoices to extract/predict key fields. This training process involves feeding the model with examples of invoices along with their corresponding correct field values. The model learns patterns and relationships within the data to make predictions about the fields in new invoices. Once the ML model is trained, it can predict the values of the fields in new invoices based on the patterns it has learned from the training data. These predicted field values are then used for further processing, such as initiating bill payments or integrating with accounting systems.

However, these and other document processing technologies are inaccurate in extracting or predicting values of particular fields or entities. This is not only because generic features are extracted from documents (e.g., extracting the word “total” from the document to infer total amount due), but because user behavior is often inconsistent with predictions in the document. For example, these existing technologies may predict that the amount due for a vendor to pay is a value under “total amount due” based on a model having been trained on millions of invoices to recognize that “total amount due” corresponds to what the user must pay. However, some vendors may not just pay the total amount due, but also the previous balance, which has not been paid. In another example, existing document processing technologies may predict that the due date to pay an invoice on is a value under the field “auto-pay” (automatic payment processing) based on using NLP and training a model to strictly predict payment due values. However, a given vendor may consistently pay on a “billing date” (a separate field in the document), which is the date the payment is actually due and not the same as auto-pay date. According, for this given vendor, these predictions would be inaccurate.

Existing technologies and computers themselves also consume an unnecessary amount of computing resources, such as excessive computer input/output (I/O) and network latency, based on an unnecessary high amount of manual user input. In these existing technologies, if the automatically extracted/predicted values of fields are not correct or require modification, the user has the option to manually adjust them. However, this modification is excessive (users are always changing model predictions) due to the inaccurate predictions described above with these existing technologies. For example, using the illustration above, users would have to keep changing the payment due date from the “auto-pay” date to the billing date. Computationally, what this means is that there is excessive I/O. Excessive I/O wears on storage device components, such as a read/write head, because each request to change the model predictions requires, for example, a read/write head to mechanically locate corresponding sectors and tracks remove and replace the prediction, which leads to excessive wear, tear, and heat damage because there are many prediction modifications made. Further, each request to change these model predictions typically requires those requests to be transmitted over a network. For example, in order to communicate with a host, a TCP/IP packet, which incudes, headers, checksums, or other metadata must be formatted and multiple communications (e.g., network handshaking) must occur to process such requests. Accordingly, network latency is excessive.

Similarly, when there is excessive communication over a network (as is the case in existing technologies when model predictions are modified), it leads to several issues that affect bandwidth. For example, when there is too much traffic on a network, it can become congested. This congestion can slow down data transmission for all users on the network, reducing the available bandwidth for each connection. Further, excessive communication can result in packet loss, where data packets are dropped during transmission due to congestion or network errors. When packets are lost, they need to be retransmitted, which consumes additional bandwidth and further slows down the network.

Various embodiments of the present disclosure provide technical solutions that have technical effects relative to one or more of the technical problems described above with respect to document processing technologies. Particular embodiments relate to document field prediction based on user behavior and feature generation. Specifically, various embodiments have the technical effect of improved accuracy with respect to field/entity value prediction (e.g., predicting that the amount due is X) relative to document processing technologies. This is at least partially because of the technical solution of accessing or generating unique features from one or more documents previously used by a user. For example, at a first time, some embodiments receive a first document from a user device of a first vendor. Some embodiments may then generate a user profile of the first vendor (e.g., create a data structure with a vendor ID mapped to data in the first document). Responsively, some embodiments may then generate one or more unique features of the first document, such as what the surrounding words for particular field(s)/value(s) are, the positional coordinates of such words, the Euclidian distance between those surrounding words from the field(s)/value(s), page number, and/or the like. At a second time subsequent to the first time, the same first vendor may then upload a second document. Various embodiments may then match the second document (and/or unique identifier (e.g., a MAC address) of the user device) to the first vendor. Then, particular embodiments may then access, from computer storage, such features that were generated after the user profile was generated, which gives clues or indications of what the fields and/or values are within the second document.

Various embodiments additionally or alternatively have the technical effect of improved accuracy because some embodiments access and utilize user behavior data associated with historical document(s) for predictions. For example, using the illustration above, a base machine learning model may have predicted that the “amount due” (as found in accounting software) was “X,” because this value was a part of a “Total Amount Due” field in the first document. However, the user may have changed the X value to Y, which is indicative of total amount due plus amount owed. Various embodiments record or store, in computer storage, such change by the user or other user behavior associated with the first document. Accordingly, when particular embodiments predict the “amount due” from processing the second document, particular embodiments access such user behavior previously recorded for the first document and correctly infer that the amount due is Y and not X. According, for this given first vendor, these predictions would be more accurate relative to existing document processing technologies.

Various embodiments and computers themselves also have the technical effect of reduced computing resource consumption, such as reduced computer I/O and reduced network latency. This is at least partially because there is no or less manual user input. Because there is a higher likelihood that the automatic extraction/prediction of values of fields will be correct (as described above with respect to improved accuracy), user adjustments or modification will be required less often. For example, using the illustration above, users would not have to keep changing the payment due date from the “auto-pay” date to the “billing date.” Rather, various embodiments correctly predict that the payment due date is a value under the “billing date” field. Computationally, what this means is that there is less computer I/O. Consequently there is less wear on storage device components, such as a read/write head, because, for example, the read/write head would have to mechanically locate corresponding sectors and tracks fewer times. This means that there is less wear, tear, and heat damage because there are no/fewer user modifications made to model predictions. Further, various embodiments have the technical effect of reduced network latency. This is because there are less packets generated (and thus headers, checksums, etc.) and less communication over a network. This because there are no or fewer requests to change these model predictions (due to the improved accuracy described above), which means that fewer (or none) of those requests are transmitted over a network. Accordingly, network latency is reduced.

Similarly, various embodiments save on bandwidth resources. This is also because there is no or fewer user requests to change model predictions, which means there is less communications transmitted over a network. Accordingly, when there is not as much traffic on a network, there is less congestion. Less congestion means that data transmission is sped up for all users on the network, increasing the available bandwidth for each connection. Further, less communication over a network (because of the fewer requests described above) results in less packet loss, so not as much data packets are dropped during transmission due to less congestion or network errors. When packets are not lost, they do not need to be retransmitted, which frees up additional bandwidth and further speeds up the network.

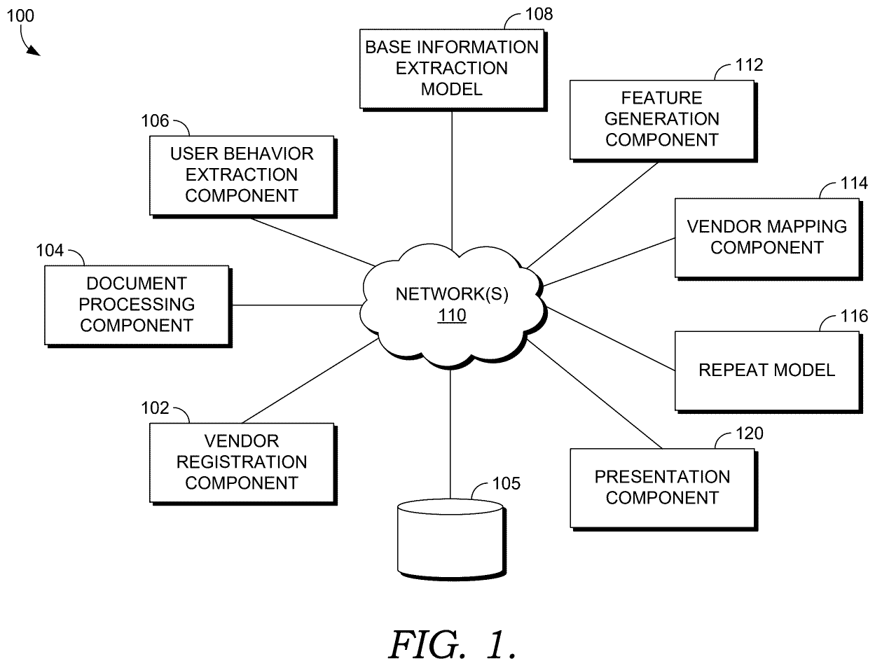

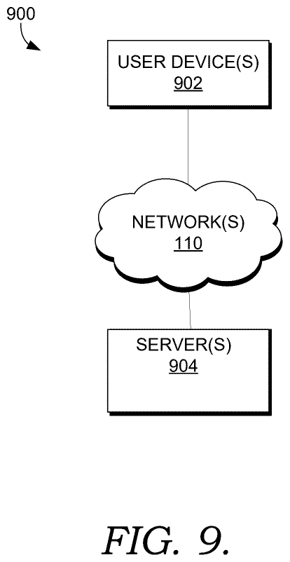

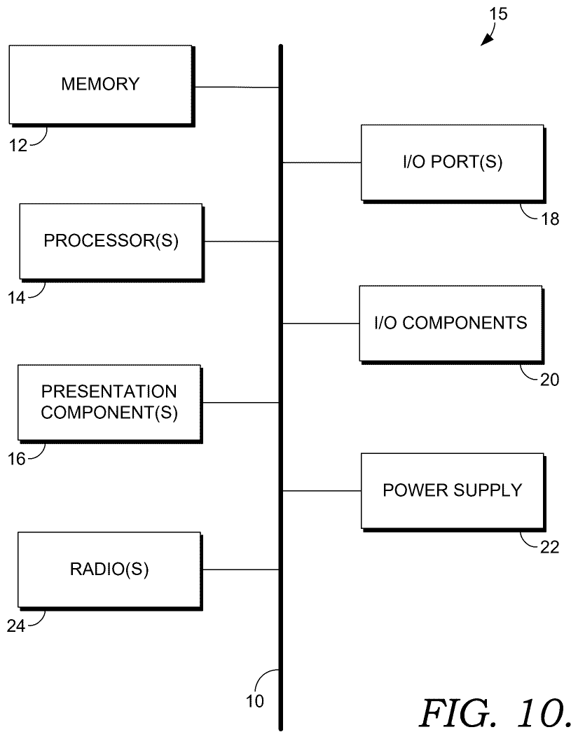

FIG. 1 is a block diagram of an illustrative system architecture 100 in which some embodiments of the present technology may be employed. Although the system 100 is illustrated as including specific component types associated with a particular quantity, it is understood that alternatively or additionally other component types may exist at any particular quantity. In some embodiments, one or more components may also be combined. It is also understood that each component or module can be located on the same or different host computing devices. For example, in some embodiments, some or each of the components within the system 100 are distributed across a cloud computing system (e.g., the computer environment 900 of FIG. 9). In other embodiments, the system 100 is located at a single host or computing device (e.g., the computing device 1000 of FIG. 10). In some embodiments, the system 100 illustrates executable program code such that all of the illustrated components and data structures are linked in preparation to be executed at run-time.

System 100 is not intended to be limiting and represents only one example of a suitable computing system architecture. Other arrangements and elements can be used in addition to or instead of those shown, and some elements may be omitted altogether for the sake of clarity. Further, many of the elements described herein are functional entities that may be implemented as discrete or distributed components or in conjunction with other components, and in any suitable combination and location. For instance, the functionality of system 100 may be provided via a software as a service (SAAS) model, e.g., a cloud and/or web-based service. In other embodiments, the functionalities of system 100 may be implemented via a client/server architecture.

The system 100 is generally directed to predicting or extracting one or more values of one or more fields. The system 100 includes a vendor registration component 102, a document processing component 104, a user behavior extraction component 106, a base information extraction model 108, a feature generation component 112, a vendor mapping component 114, a repeat model 116, a presentation component 125, and storage 125, each of which are communicatively coupled to the network(s) 110. The network(s) 110 can be any suitable network, such as a Local Area Network (LAN), a Wide Area Network (WAN), the internet, or a combination of these, and/or include wired, wireless, or fiber optic connections. In general, network(s) 110 can represent any combination of connections (e.g., APIs or linkers) or protocols that will support communications between the components of the system 100.

The vendor registration component 102 is generally responsible for registering a user by generating a user profile. In some embodiments, the generation of the user profile is done manually. For example, upon creating an account at an application, the user may be prompted to input various information, such as name, business, credit card information, and/or upload one or more documents (e.g., bills or invoices). For example, upon receiving this information from the user, the vendor registration component 102 may create a lookup data structure with the user's name as a key or record and all other information (e.g., documents) as values. Additionally or alternatively, in some embodiments the generation of the user profile is automated for at least some information. For example, in response to establishing a communication session between a user device and a server (e.g., via network handshaking), particular embodiments open up a communication channel. Upon opening such communication channel, the user device may pass or return or geocoded indicator (e.g., a MAC address, an IP address, and/or device fingerprint) to the server. The user device may additionally transmit, over the network(s) 110, a first document to the server, such as an invoice. The server may then create a dictionary or other key-value pair, where the key is the geocoded indicator and the values represent the document. In this way, for future computer sessions, the user and/or documents that the user uploads may be mapped via the vendor mapping component 114, as described in more detail below.

The document processing component 104 is generally responsible for processing one or more raw documents uploaded or otherwise provided by the user. For instance, the document processing component 104 may convert one or more raw documents into another format in preparation for further processing (e.g., by a machine learning model). For example, in some embodiments the document processing component 104 performs (or calls and obtains from a service) optical character recognition (OCR) functionality on characters located in the raw document. OCR detects natural language characters and converts such characters into a machine-readable format (e.g., so that it can be processed via a machine learning model). In an illustrative example, an OCR component can perform image quality functionality to change the appearance of the document by converting a color document to greyscale, performing desaturation (removing color), changing brightness, and changing contrast for contrast correctness, and the like. Responsively, the OCR component can perform a computer process of rotating the document image to a uniform orientation, which is referred to as “deskewing” the image. From time to time, user-uploaded documents are slightly rotated or flipped in either vertical or horizontal planes and in various degrees, such as 45, 90, and the like. Accordingly, some embodiments deskew the image to change the orientation of the image for uniform orientation (e.g., a straight-edged profile or landscape orientation). In some embodiments, in response to the deskew operation, some embodiments remove background noise (e.g., via Gaussian and/or Fourier transformation). In many instances, when a document is uploaded, such as through scanning or taking a picture from a camera, it is common for resulting images to contain unnecessary dots or other marks due to the malfunction of printers. In order to be isolated from the distractions of this meaningless noise, some embodiments clean the images by removing these marks. In response to removing the background noise, some embodiments extract the characters from the document image and place the extracted characters in another format, such as JSON. Formats, such as JSON, can be used as input for other machine learning models, such as Convolutional Neural Networks (CNN) for object detection and/or NLP models for language predictions, as described in more detail below.

Alternatively or additionally, the document processing component 104 performs machine learning pre-processing steps on one or more documents, such as vectorization, data wrangling, data munging, scaling, and the like. Vectorization is the process of converting natural language textual data into numerical vectors that can be understood and processed by machine learning algorithms. This transformation is crucial because most machine learning models, such as neural networks, support numerical inputs rather than raw text. For example, the first step is to break down the text into smaller units called tokens. These tokens can be words, phrases, or even characters, depending on the chosen approach. Text data often contains variations in capitalization, punctuation, and other formatting. Normalization standardizes these variations to ensure consistency in the vectorized representation. Common normalization techniques include converting all text to lowercase and removing punctuation. Stopwords are common words like “the,” “and,” “is,” etc., which often occur frequently in text but carry little meaningful information. Removing stopwords can help reduce the dimensionality of the vectorized representation and improve the performance of the model. Feature extraction involves converting the tokens into numerical features (e.g., view Bag of Words). Word embeddings represent words in a continuous vector space where semantically similar words are closer to each other. Techniques like Word2Vec, GloVe, and FastText are commonly used for generating word embeddings. Once the features are extracted, each document is represented as a numerical vector, where each element corresponds to a specific feature (e.g., token) in the text. These vectors are then fed into the machine learning model for training or prediction.

The user behavior extraction component 106 is generally responsible for extracting and storing, to storage 105, user behavior data. “User behavior” or “user behavior data” as described herein refers to any computerized user input that a user engages in, such as modifying a value prediction of a field, clicking on a user interface element, issuing a query, paying a particular amount or otherwise incorporating a particular value for a given field (e.g., “invoice due date”), navigating through different pages, drilling down on a user interface, populating fields with values (e.g., strings) on a document, or otherwise interacting with a page (e.g., web page or app).

In an illustrative example, the user behavior extraction component 106 may represent or use event tracking functionality. Event tracking involves capturing and recording user interactions or system events within an application or system. These interactions could include actions such as clicking buttons, entering text (e.g., into accounting software fields), navigating pages, submitting forms, and more. Event tracking starts with instrumenting the application or system to detect and capture user interactions. This involves adding code to various parts of the application to monitor and respond to user actions. Some embodiments define the types of events that the system needs to track. These events could include user actions such as clicks, keystrokes, form submissions, page views, etc. Various embodiments then attach event listeners to relevant UI elements or components within the application. Event listeners are functions or callbacks that are triggered when a specific event occurs, such as a button click or form submission. When a user performs an action that corresponds to a tracked event, the associated event listener is triggered. For example, if a user clicks on a button, the click event listener attached to that button will be executed. Within the event listener, capture relevant data associated with the event. This could include information such as the type of event, timestamp (e.g., indicating when a user made a particular modification), user ID, page URL, form field values, and any other contextual information needed to understand the event. Once the relevant data is captured, some embodiments log the event along with the captured data to a centralized location. This could be a log file, a database, or an analytics platform. Some embodiments then store, to storage 105, the logged events in a structured format for later analysis and retrieval. This could involve writing the events to a database table, appending them to a log file, or sending them to a cloud-based analytics service. Some embodiments implement measures to ensure the security and privacy of the tracked event data. This may include encrypting sensitive data, anonymizing user identifiers, and enforcing access controls to restrict access to authorized users.

The base information extraction model 108 (e.g., a machine learning model) generally responsible for extracting/predicting values for fields of document(s) by taking, as input, document(s) processed by the document processing component 104. For example, classification models may be used for tasks like determining the type of document (e.g., invoice, receipt) or extracting specific fields (e.g., due date, invoice number). Example algorithms include Support Vector Machines (SVM), Random Forest, and Gradient Boosting Machines. For tasks involving sequences, such as Named Entity Recognition (NER) for extracting entities like dates, amounts, or vendor names, sequence models may be used, such as Recurrent Neural Networks (RNNs), Long Short-Term Memory networks (LSTMs), or Transformer-based models (e.g., BERT).

Regression Models may be used for predicting numerical values, such as the total amount due. Linear Regression, Decision Trees, or more advanced techniques like Neural Networks can be employed.

In some embodiments, the based information extraction model 108 is trained on a labeled dataset where the input is the preprocessed invoice data, and the output is the desired field values (e.g., total amount, due date) or labels indicating the presence of specific information. During training, the model learns to map input features to the target output values through optimization algorithms like gradient descent. The trained model is evaluated on a separate validation dataset to assess its performance. Metrics such as accuracy, precision, recall, F1-score, or Mean Absolute Error (MAE) may be used depending on the nature of the task (classification or regression). The model may undergo further fine-tuning and optimization to improve its performance. Techniques like hyperparameter tuning, ensemble methods, or transfer learning (using pre-trained models) can be employed. Once the model achieves satisfactory performance, it can be deployed into production systems where it processes new invoice data in real-time or in batch mode, extracting or predicting field values as required.

In some embodiments, the based information extraction model 108 (and/or the repeat model 116) includes a table detector that is generally responsible for determining a table in a document. Such determination may include a classification of the type of table (e.g., a line item table) and/or the bounding box coordinates of the table. Some embodiments cause presentation, on a document, of an indication of the prediction and/or a spatial location within the document where the predicted table is derived from. For example, some embodiments use a computer vision-based machine learning model (e.g., a Convolutional Neural Network (CNN)) to detect a table in a document via a bounding box. A bounding box describes or defines the boundaries of an object (e.g., a table) in terms of the position (e.g., 2-D or 3-D coordinates) of the bounding box (and also the height and width of the bounding box). Bounding boxes thus define the boundaries and encompasses a computer object representing a table object of a document. For example, the bounding box can be a rectangular box that is determined by its X and Y-axis coordinates, which is formulated over a table. In this way, for example, a bounding box can be generated or superimposed over a table that includes the numerical value of $13,500 and natural language indicia reading “total invoice value.” Bounding boxes give object recognition systems indicators of the spatial distinction between objects to help detect the objects in documents.

In some embodiments, one or more machine learning models can be used and trained to generate tighter bounding boxes for each object. In this way, bounding boxes can change in shape and confidence levels for classification/prediction and can be increased based on increased training sessions. For example, the output of a CNN or any other machine learning model described herein can be one or more bounding boxes over each line item table of an image, where each bounding box includes the classification prediction (e.g., this object is a line item table) and the confidence level (e.g., 90% probability).

In various embodiments, the table detector of the based information extraction model 108 classifies or otherwise predicts whether each table in each document belongs to certain classes or categories (e.g., the object detected is a line item table). These predictions or target classifications may either be hard (e.g., membership of a class is a binary “yes” or “no”) or soft (e.g., there is a probability or likelihood attached to the labels). Alternatively or additionally, transfer learning may occur. Transfer learning is the concept of re-utilizing a pre-trained model for a new related problem.

In some embodiments, the table detector performs its functionality based on training one or more machine learning models to recognize the type of table needed, such as a line item table. For instance, ground truth line item tables can be used in training, where the tables themselves, the headers, rows, and/or columns can be labeled. For instance, tables can be labeled as line item tables, and columns of a line item table can be labeled as “description” columns, indicative of a header. Description columns describe the item and/or service for which an expense is due. In another example, columns of a line item table can be labeled as “amount,” which describes, typically in numerical characters, the specific amount due for the corresponding item. In yet another example, columns of a line item table can be labeled as “quantity,” which typically describes the quantity of the item described in the “description” column that has been purchased. Each of these columns are indicative of a table being a line item table. In this way, the models that the table detector 104 uses can learn that these features are indicative of line item tables after optimizing a loss function (e.g., a Faster-RCNN loss function) over various training epochs. In yet other examples, a column of a line item table can be labeled as a quantity/unit price column. A “quantity” column, for example, describes a quantity of items and/or service for which an expense is due. A “unit price” column describes a cost per item (as opposed to a total cost) or a cost per unit (e.g., liter, pound, etc.). In some embodiments, the table detector 104 uses other non-line-item tables to train on in order to distinguish between tables. In some embodiments, the detected table need not be a line item table, but any suitable table that has any characters or numbers inside the table (e.g., as indicated in a spreadsheet).

In some embodiments, the bounding box coordinates themselves or specific tables can be learned based on the location of tables in training data, the dimensions of tables in the training data, and the like. For example, for a first entity or vendor, if a line item table is always located at the bottom right part of a document, the models can learn this position such that at a future time for the first entity, if another table is located in the same position, it can be predicted with high confidence that the table is a line item table. Additional functionality for detecting tables is described in more detail below.

The feature generation component 112 is generally responsible for generating and storing, to storage 105, one or more features for one or more fields and/or values in a document. In some embodiments, such features describe, via metadata, the values/fields in some way (e.g., relative to corresponding values/fields of prior uploaded documents). The feature generation component 112 is executed after each user interaction, so that it captures the latest user behavior pattern(s). By keeping updating the predetermined features, it allows the system to continually perform reinforcement learning from human feedback (RLHF) by rewarding the common patterns and penalizing the one-off behaviors. For example, such features can include an indication of whether a candidate field in a current invoice document is located below a labeled field from a previous invoice document. This helps identify spatial relationships between fields across different invoices. In another example, such features may additionally or alternatively include horizontal distance between the candidate field in the current invoice document and the labeled field found in the same document. This distance metric provides spatial context for the relationship between fields. Other features may additionally or alternatively exist, as described in more detail below.

Reinforcement learning from human feedback (RLHF) is an approach in machine learning where a model learns to perform tasks by receiving feedback from humans. Instead of relying solely on predefined reward functions or labels, the model is trained using human judgments to improve its performance iteratively. This method combines reinforcement learning (RL), where an agent learns by interacting with an environment and receiving rewards, with supervised learning, where a model learns from labeled examples provided by humans. In RLHF, human feedback acts as a guiding signal for the model, helping it understand which actions or predictions are desirable and which are not. This approach is particularly useful in tasks where defining an explicit reward function is challenging or where human judgment is critical for determining the quality of the model's output.

Consider a model that needs to extract specific fields, such as the payment due date, from bills or invoices. The model is initially trained on a dataset of bills or invoices with labeled fields (e.g., payment due date, total amount due). This training can use supervised learning techniques to get a baseline model. The model is then deployed to extract fields from new, unseen bills or invoices. Human reviewers examine the model's predictions and provide feedback, indicating whether the predictions are correct or incorrect. The feedback from human reviewers is used to adjust the model. If a prediction is incorrect, the model learns to avoid similar mistakes in the future. Conversely, if a prediction is correct, the model reinforces this behavior. This process is repeated iteratively. The model continuously interacts with new bills or invoices, receives human feedback, and updates its predictions based on this feedback. Over time, the model becomes more accurate in extracting the desired fields.

In an illustrative example, the model predicts the payment due date on a new invoice as “2024 Jul. 10”. A human reviewer (e.g., an actual vendor or user of a bill payment system) checks the prediction and finds that the actual payment due date is “2024 Jul. 15”. The reviewer provides feedback indicating the mistake. The model receives this feedback and updates its parameters to reduce the likelihood of making similar mistakes in the future. For example, it might learn to give more weight to certain textual cues that correctly indicate the payment due date. In the next iteration, the model encounters another invoice and predicts the payment due date as “2024 Aug. 5”. The human reviewer confirms that this prediction is correct, and the model reinforces this behavior. Over multiple iterations, the model refines its ability to predict the payment due date by learning from the cumulative human feedback. The model becomes better at identifying and interpreting relevant information in the invoices. By leveraging human feedback, the model can learn more nuanced and context-specific patterns that might be difficult to capture with predefined rules or purely supervised learning.

The vendor mapping component 114 is generally responsible for mapping an incoming document and/or user to a user that has registered a user profile via the vendor registration component 102. For example, in some embodiments, after a user registers and a user profile for the user has previously been generated, some embodiments receive a second document uploaded by the user. In some embodiments, the document processing component 104 responsively vectorizes the second document and then computes a distance (e.g., via KNN and Euclidian distance) between a second vector representing the second document and a first vector representing the first document uploaded by the user at registration time (or other previous session). Based on the first vector being closest to the second vector, embodiments then map the second vector back to the user (e.g., via a lookup table) to associated the user with the second document. Alternatively or additionally, upon establishing a communication with a session between a user device and server, the server may automatically receive a geocoded indicator as described above. Such geocoded indicator may then be mapped back to the user (e.g., via a lookup structure) in order to associate the second document with the first document that was provided at registration time.

The Repeat Model (RM) 116 is generally responsible for taking, as input, at least the user behavior extracted by the user behavior extraction component 106 and the features generated by the feature generation component 112 in order to predict/extract one or more values in a document at runtime (e.g., a time after the user has had a user profile created and/or has previously uploaded a document). For example, in some embodiments the repeat model 16 is trained using historical invoice data, including user behavior data and the generated features as input. The training dataset in some aspects includes labeled examples where the input features (corresponding to the features generated by the feature generation component 112) are the characteristics of the invoice documents, such as spatial relationships, distances, and quadrant IDs, along with user behavior data indicating corrections or adjustments made by users. The RM 116 learns patterns and relationships between the input features and the corresponding correct values of the fields within the invoice documents. Each invoice document is represented as a set of features, including the features generated from the document itself (e.g., spatial relationships) and features derived from user behavior data (e.g., corrections made by users). The features are structured in a format suitable for input into the machine learning model, such as numerical vectors or tensors. The RM 116 is trained to minimize a loss function that measures the difference between the predicted values and the ground truth values of the fields within the invoice documents. The loss function penalizes deviations between the predicted values and the actual values, encouraging the model to learn accurate mappings between the input features and the target values. During the prediction process, the model takes as input the features of a new, unseen invoice document, along with any relevant user behavior data. The model applies the learned patterns and relationships to generate predictions for the values of the fields within the invoice document. These predictions are based on the input features and the historical context provided by the user behavior data, allowing the model to adapt its predictions based on past user interactions and corrections. Overall, the repeat model 116 leverages user behavior data and generated features to learn patterns and relationships in invoice documents, enabling it to predict or extract values accurately based on the input features and historical context provided by users.

In some embodiments, the repeat model 116 (and model 220) is a gradient boosting model. A gradient boosting model is a machine learning technique for regression and classification problems that builds a model in a stage-wise fashion. It is a powerful ensemble method that combines the predictions of several base models, typically decision trees, to produce a final predictive model. The key idea is to build new models that correct the errors of the existing models.

In an illustrative example, some embodiments train an initial gradient boosting model (e.g., using XGBoost) to predict the likelihood that a given text snippet or numerical value on the invoice is the “Total Amount”. Various embodiments apply the initial model to make predictions on the training data. Various embodiments calculate the residuals, which are the differences between the actual “Total Amount” values and the predicted values. Various embodiments then train a new model to predict the residuals. This model helps to capture patterns that were not captured by the initial model. Some embodiments then add the predictions of the new model to the previous predictions to get updated predictions. Embodiments repeat the process of computing residuals, training new models, and updating predictions for a specified number of iterations. After several iterations, the ensemble of models collectively provides a robust prediction of the “Total Amount” field.

The presentation component 120 is generally responsible for causing presentation of one or more elements, such as an accounting software user interface, one or more documents uploaded by a user, and/or indications (e.g., highlighted values) of the extractions/prediction made by the RM 116 at a user device. In some embodiments, such presentation is in the form of a user interface. Such user interface may be a graphical user interface (GUI), and/or a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on a user device.

Based on content logic, device features, associated logical hubs, inferred logical location of the user, and/or other user data, presentation component 120 may determine on which user device(s) content is presented, as well as the context of the presentation, such as how (or in what format and how much content, which can be dependent on the user device or context) it is presented and/or when it is presented. In some embodiments, the presentation component 120 generates user interface features. Such features can include interface elements (such as graphics buttons, sliders, menus, audio prompts, alerts, alarms, vibrations, pop-up windows, notification-bar or status-bar items, in-app notifications, bubble data objects, or other similar features for interfacing with a user), queries, and prompts.

Storage 105 generally stores information including data (e.g., user profiles, documents, user behavior, predictions from the base information extraction model 108, features), computer instructions (for example, software program instructions, routines, or services), data structures, and/or models used in embodiments of the technologies described herein. In some embodiments, storage 105 represents any suitable data repository or device, such as a database, a data warehouse, RAM, cache, disk, RAID, and/or a storage network (e.g., Storage Area Network (SAN)).

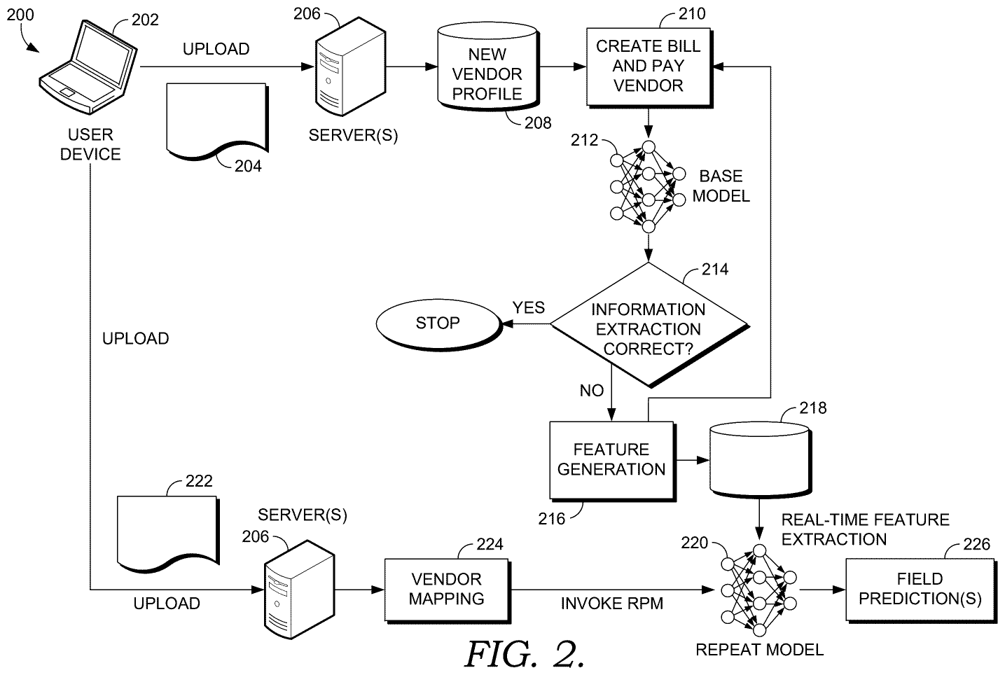

FIG. 2 is a block diagram of an example pipeline 200 for extracting/predicting one or more values associated with one or more fields of a document, according to some embodiments. At a first time, a user device 202 uploads the document 204 to one or more servers 206 (e.g., corresponding to a bill payment service). The server(s) 206 responsively generate a new vendor profile 208. In some embodiments, the vendor registration component as described with respect to FIG. 1 is the component responsible for generating the new vendor profile 208. In other words, a user profile for the user or vendor that uploaded the document 204 is created in order to, for example, record and store the vendor name, the document 204, and other information.

Next, various embodiments perform step 210 to create a bill and pay vendor, which are functionalities included in accounting software. In some embodiments, the document processing component 104 includes the functionality in 210. Bill payment services automate and streamline the process of creating bills, managing approvals, and executing payments, helping organizations to improve efficiency, accuracy, and control over their financial operations. The process in 210 begins when the vendor sends the document 204 (e.g., an invoice) to the business or organization for goods or services rendered. The invoice may be received in various formats, including paper, email, or electronic file (PDF). The invoice is captured and digitized using Optical Character Recognition (OCR) technology if it's in a non-digital format. The relevant information from the invoice, such as vendor name, invoice number, date, line items, quantities, prices, and total amount due, is extracted. This data extraction process involves using a machine learning model (i.e., a “base model”) 212 and natural language processing techniques to interpret and extract information accurately. In some embodiments, the base model 212 represents the base information extraction model 108 as described with respect to FIG. 1.

After the base model 212 performs its extraction/predictions, it is determined, via 214, if the information extraction was correct. In some embodiments, such determination is based on receiving manual user input. For example, the extracted data is presented to the user or designated personnel for review and approval. Users verify the accuracy of the extracted information and make any necessary corrections or adjustments. In some embodiments, approval is required from specific individuals or departments within the organization before proceeding with payment to the vendor as indicated in 210. In some embodiments, information extraction at block 214 is performed automatically via different validation metrics, such as precision and recall, F1 score, accuracy, Mean Absolute Error (MAE), Mean Squared Error (MSE), Root Mean Squared Error (RMSE), Intersection over union or the like.

At block 216, if the information extraction from 214 is not correct, then one or more embodiments generate one or more features, as described, for example with respect to the feature generation component 112. Particular embodiments then store the document 204, as well as the features within the data store 28 (e.g., the storage 105 of FIG. 1). Once the invoice details are confirmed and approved (e.g., after “yes” decision at 214 and/or 216), the system generates a payment authorization. This authorization may include details such as the payment amount, payment method (e.g., ACH, wire transfer), and scheduled payment date. The payment authorization triggers the transfer of funds from the organization's bank account to the vendor's bank account. Depending on the payment method chosen and the recipient's banking institution, the processing time may vary. After the payment is processed successfully, a confirmation notification is sent to both the organization and the vendor. The confirmation typically includes details such as the payment reference number, transaction date, and amount transferred. The details of the payment transaction may be recorded and stored in the organization's accounting or financial management system data store. This information is used for reconciliation purposes to ensure that payments match with corresponding invoices and financial records.

At a second time, the same user that uploaded the document 204, uploads another document 222 to the server(s) 206. At block 224, the document 222 and/or the user that uploaded the document 222 is mapped to the vendor, as described, for example, with respect to the vendor mapping component 114 of FIG. 1. Responsive to such mapping, various embodiment extract relevant information about the user, such as the new vendor profile 208, the user's behavior data, and/or the features stored to the data store 218 (via real-time feature extraction as illustrated in FIG. 2). One or more sets of such relevant information is then fed, as input, into the response model 221 in response to an “invoke RPM” command. The repeat model 220 then generates an output that includes the field prediction(s) 226. For example, accounting software that is configured to pay a bill (e.g., document 222) uploaded by the vendor may include an “amount due field.” The repeat model may predict that the amount due is “$2,000” based on extracted features, such as “$2,000” being next to a corresponding field on the document 222 called “total amount,” as well as based on user behavior at document 204, where the user paid the same amount, which also corresponds to the “total amount” field.

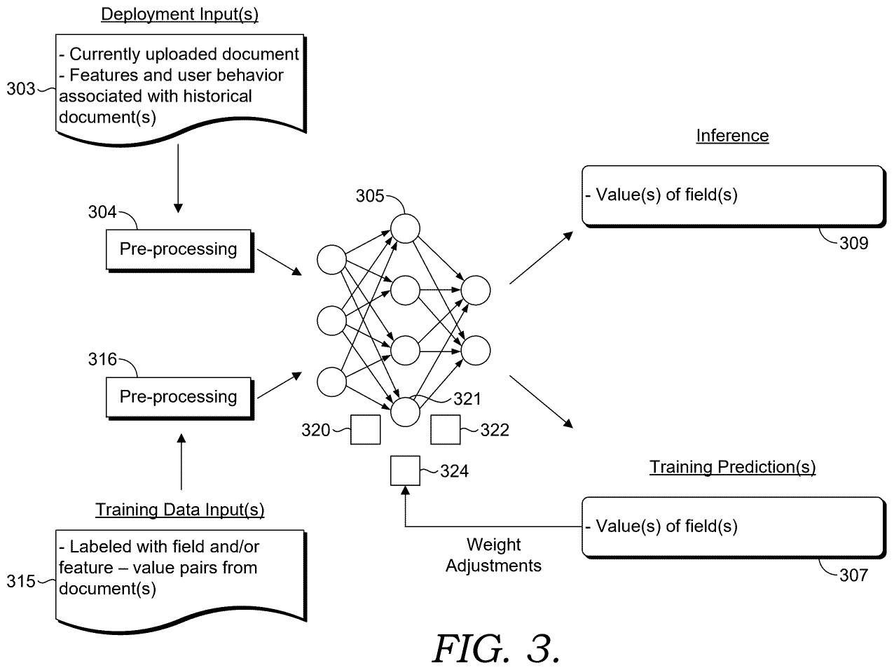

FIG. 3 depicts a diagram of an example neural network 305 trained to predict one or more values of one or more fields (e.g., in accounting software and/or at a document), according to some embodiments. In some examples the neural network 305 represents or includes the Repeat model 116 of FIG. 1 and/or the repeat model 220 of FIG. 2. In some examples, the neural network 305 represents any suitable model functionality, such as supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

The neural network 305 is modeled as a data flow graph (DFG), where each node (e.g., 321) in the DFG is an operator with an input and output tensor, such as 320 and 322. A “tensor” (e.g., a vector) is a data structure that contains values representing the input, output, and/or transformations processed by the operator. Each edge of the DFG depicts the dependency between the operators. Neural network 305 includes an input layer, an output layer and a hidden layer. An Input layer is the first layer of the neural network 305. The input layer receives pre-processed (e.g., via the pre-processing 304 or 316) input data represented by 303 and 315, such as a currently uploaded document and features/user behavior, or the like. The Output layer is the last layer of neural network 305. The output layer extracts or predicts one or more values for one or more given fields, which is represented by the inference and predictions 309 and 307. Neural network 305 may include any number of hidden layers. Hidden layers are intermediate layers in neural network 305 that perform various operations.

Each node in FIG. 3, such as node 321, is associated with or includes an activation tensor, such as input tensor 320, output tensor 322, and/or intermediate tensors. An “activation tensor” is a tensor that is an input, intermediate, and/or output to at least one neural network layer (e.g., as modeled going from left to right), as illustrated by the flow of data from input tensor 320 to output tensor 322. This is different than a weight tensor, such as 324, where weight tensors are modeled as flowing upward (not being actual inputs or outputs). In other words activation tensors represent some form of the neural network inputs 303 and 315. For example, the input tensor 320 or node 321 can represent specific values for a particular performance property (e.g., a specific feature, such as Euclidian distance from label/field to value), whereas a weight tensor represents the weight values indicating node activation/inhibition values indicating significance of the particular performance property for the overall prediction at 309 or 307.

Each node in the network 305 may also be associated with or include and/or a weight tensor (e.g., 324), which include weight values. A “weight” in the context of machine learning may represent the importance or significance of a feature or feature value for prediction. For example, each feature (e.g., quadrant position) may be associated with an integer or other real number where the higher the real number, the more significant the feature is for its prediction. In some aspects, a weight in a neural network represents the strength of a connection between nodes or neurons from one layer (an input) to the next layer (a hidden or output layer). A weight of 0 may mean that the input (e.g., the input tensor 320) will not change the output (e.g., the output tensor 322), whereas a weight higher than 0 changes the output. The higher the value of the input or the closer the value is to 1, the more the output will change or increase. Likewise, there can be negative weights. Negative weights may proportionately reduce the value of the output. For instance, the more the value of the input increases, the more the value of the output decreases. Negative weights may contribute to negative scores. For example, a particular position of a field on a document may be highly correlated with a specific value (e.g., a particular value is always under “total amount” field) and so neural network layers or nodes representing the specific position may be weighted higher so that that this data is activated or taken into account when making a final prediction score.

Each node of the neural network 305 may additionally perform a function using the activation tensors and weight tensors, such as activation functions, matrix multiplication, normalization, or the like. In some examples, the nodes in the neural network 305 are fully connected or partially connected. Continuing with FIG. 3, each node may process an input in 303 and 315 (or portion thereof) using activation tensors and weight tensors. In some examples, in response to receiving the deployment input(s) 303 and the training data input(s) 315, the neural network 305 first performs pre-processing 304 or 316, such as encoding or converting such input into machine-readable indicia representing the entire input (e.g., a tensor representing all of the deployment input(s) 303). Responsively, the node may then receive an input tensor, which may, for example, represent whether a feature (e.g., specific working conditions, such as whether the geometric tolerance level is between a specific range) are present in the input. In some examples, the input tensor is an N-dimensional tensor, where N can be greater than or equal to one. In some examples, an input tensor 320 represents the input data of neural network 305 if the node is in the input layer. In some examples, the input tensor 320 is also the output of another node in the preceding layer. In some examples after a node, such as the node 321, performs an operation using the input tensor 320, it generates an output tensor 322, which is then passed to the other neurons in the hidden layer and/or output layer. The output tensor 322 represents the output processed by the node 321. For example, the output tensor 322 may be a matrix representing the product of matrix multiplication or a matrix indicating whether particular values for specific fields were present. In various aspects, the output tensor 322 represents an input of another node in the succeeding layer (i.e., the output layer).

In some examples node 321 applies a weight tensor 324 to the input tensor 320 via a linear operation (e.g., matrix multiplication, addition, scaling, biasing, or convolution). All other nodes in the neural network may perform identical functionality. In some examples, the result of the linear operation is processed by a non-linear activation, such as a step function, a sigmoid function, a hyperbolic tangent function (tan h), and rectified linear unit functions (ReLU) or the like. The result of the activation or other operation is an output tensor 322 that is sent to a subsequent connected node that is in the next layer of neural network 305. The subsequent node uses the output tensor 322 as the input activation tensor to another node.

Each of the functions in the neural network 305 may be associated with different coefficients (e.g., weights and kernel coefficients) that are adjustable during training. For example, after preprocessing 316 (e.g., normalization, feature scaling and extraction) in various aspects, the neural network 305 is trained using a data set of the preprocessed training data inputs 315 in order to make acceptable loss training predictions at the appropriate weights to set the weight tensors. This will help later at deployment time to make a correct inference 309. In some aspects, learning or training includes minimizing a loss function between the target variable (for example, a correct ground truth value for a given field) and the actual predicted variable (for example, an in incorrect value for a field). Based on the loss determined by a loss function (for example, Mean Squared Error Loss (MSEL), cross-entropy loss, etc.), the loss function learns to reduce the error in prediction over multiple epochs or training sessions so that the neural network 305 learns which features and weights are indicative of the correct inferences, given the inputs. Accordingly, it is desirable to arrive as close to 100% confidence in a particular classification or inference as much as possible so as to reduce the prediction error.

Subsequent to a first round/epoch of training, the neural network 305 makes predictions with a particular weight value, which may or may not be at acceptable loss function levels. For example, the neural network 305 may process additional pre-processed training data inputs similar to 315 a second time to make another pass of predictions. This process may then be repeated over multiple iterations or epochs until the weight values in the weight tensors are learned for optimal predicted values (for example, a very precise manner in modification of geometries of different models of different parts) and/or the loss function reduces the error in prediction to acceptable levels of confidence.

In some examples, before the training data input(s) 315 (or deployment input(s) 303) are provided as input into the neural network 305, the inputs are preprocessed at 316 (or 304). In some examples, such pre-processing includes feature scaling, feature extraction, normalization, and the like. Scaling (or “feature scaling”) is the process of changing number values (e.g., via normalization or standardization) so that a model can better process information. For example, some aspects can bind number values between 0 and 1 via normalization. Other examples of preprocessing includes feature extraction, handling missing data, feature scaling, and feature selection.

Continuing with FIG. 3, in some examples, the neural network 305 is trained in a supervised manner using annotations or labels. For example, in some examples, training includes (or is preceded by) annotating/labeling training data 315 so that the neural network 305 learns associations between the features or weights and corresponding labels, which is used to change the weights/neural node connections for future predictions. For example, as illustrated in the training data input(s) 315, a document may be labeled with field and/or feature-value pairs. For instance, a document may be labeled with a particular field “Total amount” and the value that belongs to the field, such as “$2,000.” Additionally or alternatively, the document may be labeled with specific features, such as quadrant of values, X and Y coordinates of given fields and/or values, Euclidian distance between fields and/or values, and or any of the features described herein with respect to the feature generation component 112 and/or user behavior extraction component 106.

Subsequent to the neural network 305 training, the neural network 305 (for example, in a deployed state) receives the pre-processed deployment input(s) 303. When a machine learning model is deployed, it has been trained, tested, validated and packaged so that it can process data it has never processed. Responsively, in some aspects, the deployment input(s) 303 (i.e., the currently uploaded document and features/user behavior associated with historical document(s)) are fed to the neural network 305, which then uses the same weight tensors (e.g., 324) that were learned via training so that the neural network 305 can produce the correct inference predictions 309. For example, the input tensor 320 can include new values (e.g., particular values and their positions), which are then multiplied or otherwise combined with the weight tensor 324, representing the same weight values learned at training, in order to make the inference prediction(s) 309.

In some embodiments, the “currently uploaded document” in the deployment input(s) 303 represent the document 222 of FIG. 2. In some embodiments, the “feature and user behavior associated with historical document(s)” represent the features stored to the data store 218 and generated via feature generation 216 of FIG. 2, which is associated with document 204 (i.e., a “historical” document).

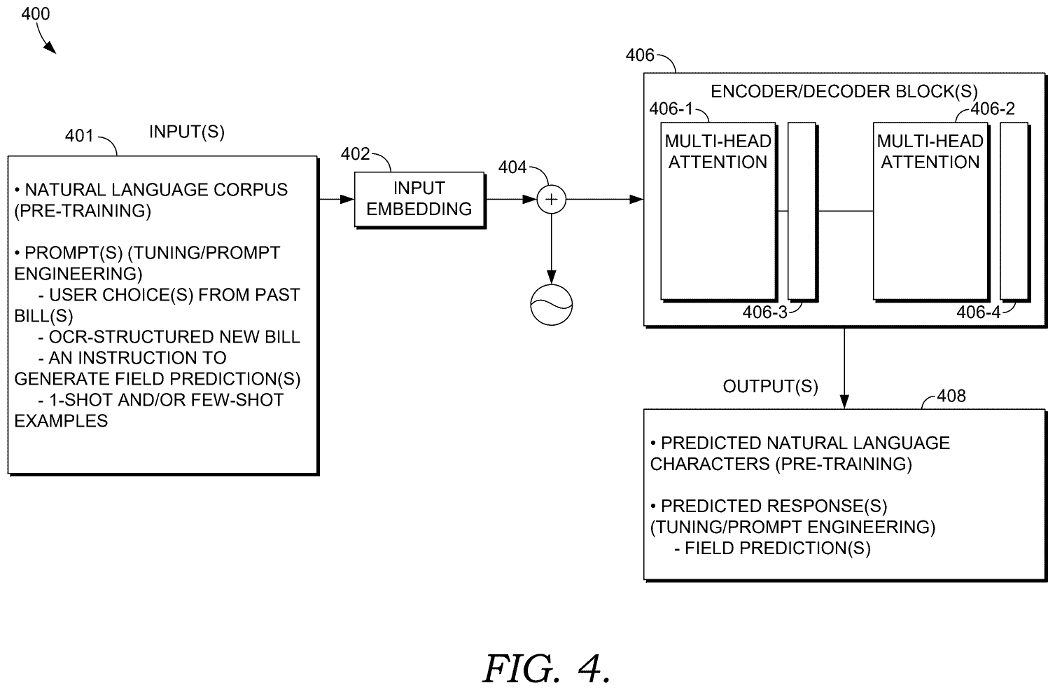

FIG. 4 is a block diagram of a Large Language Model 400 (e.g., a BERT model or GPT-4 model) that uses particular natural language input(s) to generate corresponding natural language output(s), according to some embodiments. In some embodiments, this model 400 represents or includes the functionality as described with respect to the Repeat Model 116 of FIG. 1 and/or the Repeat Model 220 of FIG. 2. In various embodiments, the LLM 400 includes one or more encoders and/or decoder blocks 606 (or any transformer or portion thereof).

At a first time, the inputs 401 are converted into tokens and then feature vectors are embedded into an input embedding 402 (e.g., to derive meaning of individual natural language words (for example, English semantics) during pre-training). In some embodiments, each word or character in the input(s) 401 is mapped into the input embedding 402 in parallel or at the same time, unlike existing long short-term memory (LSTM) models, for example. The input embedding 402 maps a word to a feature vector representing the word. But the same word (for example, “apple”) in different sentences may have different meanings (for example, a device versus a piece of fruit). This is why a positional encoder 404 may be implemented. A positional encoder 404 is a vector that gives context to words (for example, “apple”) based on a position of a word in a sentence. For example, with respect to a message “I just sent the document,” because “I” is at the beginning of a sentence, embodiments may indicate a position in an embedding closer to “just,” as opposed to “document.” Some embodiments use a sign/cosine function to generate the positional encoder vector 404 as follows:

$$P {E}_{( pos , 2 i )} = sin sin ( pos / {10000}^{2 i / {d}_{model}} )$$

$$P {E}_{( pos , 2 i + 1 )} = cos cos ( pos / {10000}^{2 i / {d}_{model}} ) .$$

After passing the input(s) 401 through the input embedding 402 and applying the positional encoder 404, the output is a word embedding feature vector (e.g., a 1D numerical sequence), which encodes positional information or context based on the positional encoder 404. These word embedding feature vectors are then passed to the encoder and/or decoder block(s) 406, where it goes through a multi-head attention layer 406-1 and a feedforward layer 406-2. The multi-head attention layer 406-1 is responsible for focusing or processing certain parts of the feature vectors representing specific portions of the input(s) 401 by generating attention vectors. For example, in Question Answering systems, the multi-head attention layer 406-1 determines how relevant the ith word is for answering the question (e.g., “what is the value for field ‘Total Amount’”) or relevant to other words in the same or other lines/sentences, the output of which is an attention vector. For every word, some embodiments generate an attention vector, which captures contextual relationships between other words in the same sentence or other sequence of characters. For a given word, some embodiments compute a weighted average or otherwise aggregate attention vectors of other words that contain the given word (for example, other words in the same line or sentence) to compute a final attention vector.

In some embodiments, a single headed attention has abstract vectors Q, K, and V that extract different components of a particular word. These are used to compute the attention vectors for every word, using the following formula:

$$Z = softmax ( \frac{Q \cdot {K}^{T}}{\sqrt{Dimension of vector Q , K or V}} ) \cdot V$$

For multi-headed attention, there may be multiple weight matrices Wq, Wk and Wv, so there are multiple attention vectors Z for every word. However, a neural network may only expect one attention vector per word. Accordingly, another weighted matrix, Wz, may be used to make sure the output is still an attention vector per word. In some embodiments, after the layers 406-1 and 406-2, there is some form of normalization (for example, batch normalization and/or layer normalization) performed to smoothen out the loss surface making it easier to optimize while using larger learning rates.

Layers 406-3 and 406-4 represent residual connection and/or normalization layers where normalization re-centers and re-scales or normalizes the data across the feature dimensions. The feedforward layer 406-2 is a feed forward neural network that is applied to every one of the attention vectors outputted by the multi-head attention layer 406-1. The feedforward layer 406-2 transforms the attention vectors into a form that may be processed by the next encoder block or by making a prediction at 408. For example, given that an invoice line includes first natural language sequence “Total Amount . . . ” the encoder/decoder block(s) 406 predicts that the next natural language sequence will be “$,2000” based on past natural language sentences that include language identical or similar to the first natural language sequence.

In some embodiments, the encoder/decoder block(s) 406 may be trained to learn language (pre-training) and make corresponding predictions. In some embodiments, the encoder/decoder block(s) 406 first learns what language and context for a word is in pre-training by training on two unsupervised tasks-Masked Language Modeling (MLM) and Next Sentence Prediction (NSP)-simultaneously. In terms of the inputs and outputs, at pre-training, the natural language corpus of the inputs 401 may be various historical documents, such as textbooks, journals, web data, and/or periodicals in order to output the predicted natural language characters in 408 (not make the predictions at tuning/prompt engineering at this point). The encoder/decoder block(s) 406 takes in a sentence, paragraph, or sequence (for example, included in the input(s) 401), with random words being replaced with masks. The goal is to output the value or meaning of the masked tokens. For example, if a line reads, “please [MASK] this document promptly,” the prediction for the “mask” value is “send.” This helps the encoder/decoder block(s) 606 understand the bidirectional context in a sentence, paragraph. In the case of NSP, the encoder/decoder block(s) 406 takes, as input, two or more elements, such as sentences, lines, or paragraphs and determines, for example, if a second sentence in a document follows (for example, is directly below) a first sentence in the document. This helps the encoder/decoder block(s) 406 understand the context across all the elements of a document, not just within a single element. Using both of these together, the encoder/decoder block(s) 406 derives a good understanding of natural language during pre-training.

In pre-training, the output is typically a binary value C (for NSP) and various word vectors (for MLM). With training, a loss (for example, cross entropy loss) is minimized. In some embodiments, all the feature vectors are of the same size and are generated simultaneously. As such, each word vector may be passed to a fully connected layered output with the same number of neurons equal to the same number of tokens in the vocabulary.

In some embodiments, once pre-training is completed, the encoder/decoder block(s) 406 performs prompt engineering and/or tuning (e.g., prompt-tuning, and/or fine tuning). For example, for fine tuning, some embodiments perform a QA task by adding a new question-answering (e.g., a field-value pair) head or encoder/decoder block in 406, just the way a masked language model head is added (in pre-training) for performing a MLM task, except that the task is a part of fine-tuning to add new input data in the input(s) 401 (i.e., the “user choice(s) from past bill(s), OCR formatted new bill, an instruction to generate field prediction(s)”) and adjust the weights formulated during pre-training. In other words, fine-tuning adds additional input data (i.e., the specific prompts in the input(s) 401 that are not part of pre-training), output tokens, and performs additional rounds of training to further adjust weights to formulate the output(s) 608 that are not part of pre-training. For example, with respect to question-answer pairs, some embodiments mask the question to test the model's knowledge of what each sequence in the question belongs to what prompt/question or use a form of NSP to predict the next sentence or word.

Prompt engineering is the process of guiding and shaping ML model responses (e.g., the predicted response(s) in the output(s) 408) by relying on the user, or prompt engineer, to craft more carefully phrased and specific queries or prompts. With prompt engineering, the weights are frozen (i.e., its values remain the same from pre-training) such that they are not adjusted during prompt engineering. A “prompt” as described herein may include one or more of the inputs in 401, a current query, code snippets, mathematical equations, one or more examples (e.g., one-shot or two-shot examples), a hard prompt or template, and/or a numerical embedding (e.g., a “soft” prompt). In some embodiments, an “example” is indicative of few-shot prompting, which is a technique used to guide large language models (LLMs), like GPT-3, towards generating desired outputs by providing them with a few examples of input-output pairs (e.g., a question asking the model to find a specific total value and an answer of the total value $,2000).

The prompt engineering process often involves iteratively asking increasingly specific and detailed questions/commands/instructions or testing out different ways to phrase questions/commands/instructions. The goal is to use prompts to elicit better behaviors or outputs as indicated in the predicted response(s) of the output(s) 608 from the model. Prompt engineers may experiment with various types of questions/commands/instructions and formats to find the most desirable and/or relevant model responses. For example, a prompt engineer may initially provide a prompt (e.g., “when do I pay the invoice”). However, this may not be specific enough/or may elicit the wrong predicted response(s) in 408 (e.g., because a document or accounting software includes multiple date options to pay a bill, such as “bill date” or “auto-pay date”), so the prompt engineer may formulate another prompt template that states, “when is the auto-pay date” and the response token may then correctly answer the value to be the auto-pay date. The prompt engineer may be satisfied with this prompt. Subsequent to this satisfactory answer, particular embodiments save the corresponding event data prompt as a template. In this way, the prompt template (e.g., a “hard” prompt) may be used at runtime or when the model is deployed.

Prompt tuning is the process of taking or learning the most effective prompts or cues (among a larger pool of prompts) and feeding them to the encoder/decoder block(s) 406 as task-specific context. For example, a common question or phrase-“how much do I owe”-could be taught to the encoder/decoder block(s) 406 to help optimize the model and guide it toward the most desirable decision or corresponding outputs in the predicted response(s) of 408. Unlike prompt engineering, prompt tuning is not about a user formulating a better question/command or making a more specific request. Prompt tuning means identifying more frequent or important prompts (e.g., which have higher node activation weight values) and training the encoder/decoder block(s) 406 to respond to those common prompts more effectively with correct predicted response(s). The benefit of prompt tuning is that it may be used to modestly train models without adding any more input(s) 401 or prompts (unlike fine-tuning), resulting in considerable time and cost savings.

In some embodiments, prompt tuning may use soft prompts only, and may not include the use of hard prompts. Hard prompts are manually handcrafted text prompts (e.g., prompt templates) with discrete responses, which are typically used in prompt engineering. Prompt templating allows for prompts to be stored, re-used, shared, and programmed. Soft prompts are typically created during the process of prompt tuning. Unlike hard prompts, soft prompts are typically not viewed and edited in text. Soft prompts typically include an embedding, a string of numbers that derives knowledge from the encoder/decoder block(s) 406 (e.g., via pre-training). Soft prompts are thus learnable tensors concatenated with the input embeddings that may be optimized for a dataset. In some embodiments, prompt tuning creates a smaller light weight model (e.g., not the LLM 400) which sits in front of the frozen pre-trained model (i.e., the LLM 400 with weights set during pre-training). Therefore, prompt tuning involves using a small trainable model before using the LLM 400. The small model is used to encode the text prompt and generate task-specific virtual tokenized tokens. These virtual tokenized tokens are pre-appended to the prompt and passed to the LLM 400. When the tuning process is complete, these tokenized virtual tokens are stored in a lookup table (or other data structure) and used during inference, replacing the smaller model.

In some embodiments, the prompt(s) in input(s) 401 and/or the predicted response(s) in the output(s) 408 correspond to concepts described herein. For example “user choice(s) from past bill(s)” may correspond to user behavior extracted by the user behavior extraction component 106 from the document 204 and/or features generated by the feature generation component 112. For instance, a user choice may be a particular modification or input of a specific value input for a specified field on accounting software and/or a document. In some embodiments, the “OCR-structured new bill” corresponds to the document 222 of FIG. 2. In an illustrative example of the “instruction to generated field predictions” corresponds to a user-issued or machine-issued query, command, and/or question to “for each field (e.g., “total amount” “payment date,” etc., return the corresponding value.” 1-shot and/or few-shot examples include, for example, query, command/question and answer pairs (e.g., “what is the total amount due in this document-$, 2000.” Similarly, in some embodiments, the field prediction(s) in the output(s) 408 is indicative of extracting and/or predicting one or more values for one or more fields (e.g., of a document and/or accounting software), as described with respect to the field prediction(s) 226 of FIG. 2.

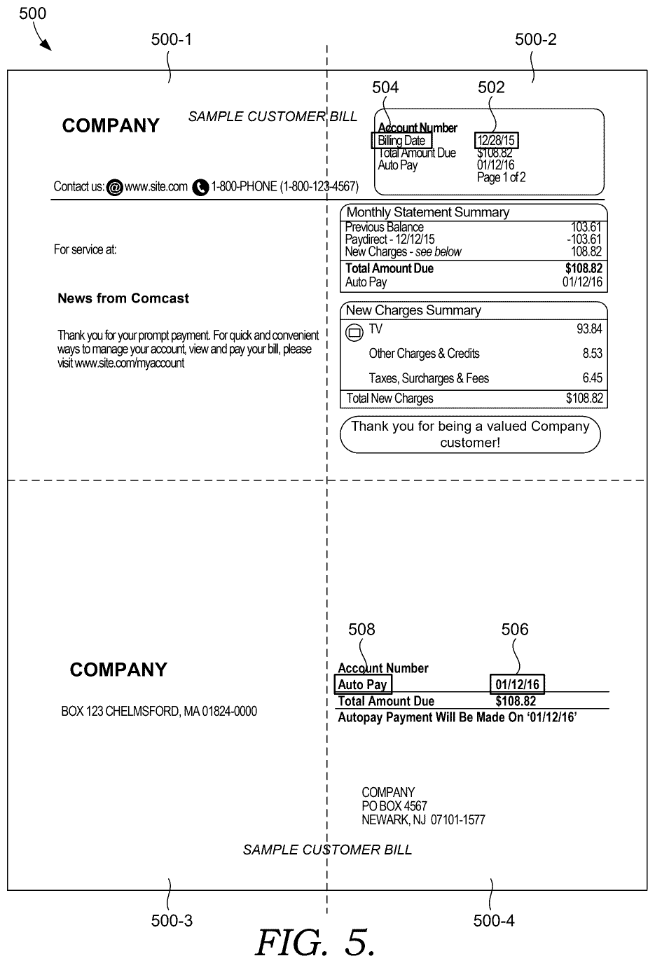

FIG. 5 is a screenshot of an example invoice 500 illustrating how the invoice 500 is parsed into four quadrants, which are used to extract features and obtain user behavior for future field predictions, according to some embodiments. In some embodiments, the invoice 500 represents a historical document, such as the document 204 of FIG. 2. Block 216, for example, extracts features from the invoice 500, such as by parsing the invoice into 4 quadrants 500-1, 500-2, 500-3, and 500-1 as illustrated in FIG. 5. Various embodiments first detect user behavior (e.g., via the user behavior extraction component 106) that the user paid a bill with a date matching the value in 502 (i.e., Dec. 28, 2015), which corresponds to the field 504 (i.e., “billing date”) as opposed to the value 506 (i.e., Jan. 12, 2016), which corresponds to the field 508 (i.e., “Auto Pay). Some embodiments not only learn the coordinates (e.g., X.Y position)/bounding box of the value indicated in 502, but the contextual information surrounding the value 502, such as the quadrant (i.e., quadrant 500-2) that the value in 502 is in, as well as the Euclidian distance the value 502 is to the field 504 and/or other spatial coordinates and words/numbers located in quadrant 500-2. In this way, for example, when a new document is uploaded, particular embodiments may take such user behavior and/or contextual information as input in order to predict that the due date for a the new document is next to a field identical to field 504, as opposed to field 508. In other words, particular embodiments predict that the payment date is on Dec. 28, 2015, as opposed to Jan. 12, 2015.

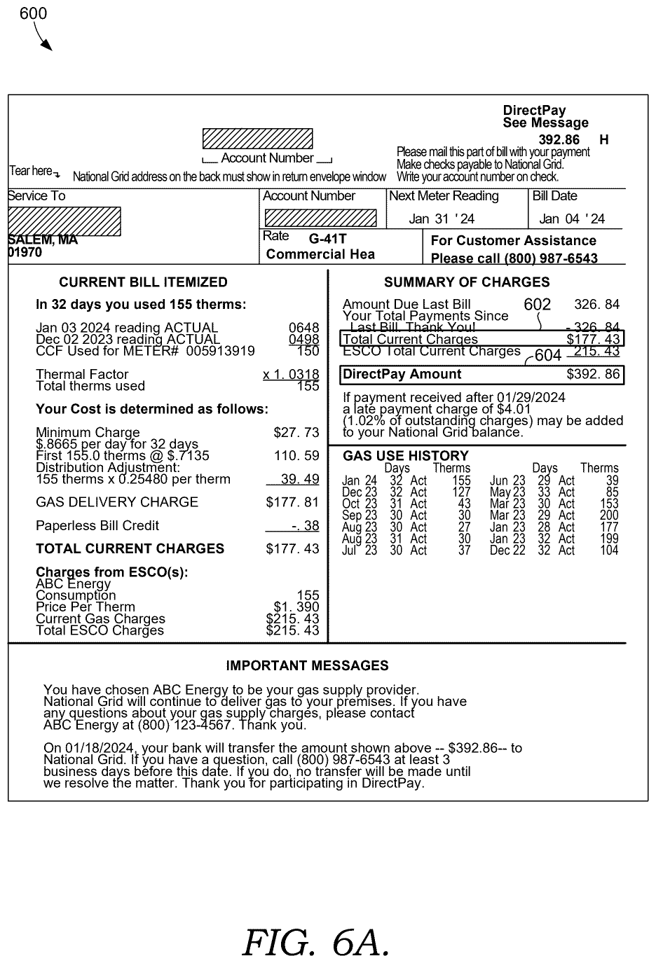

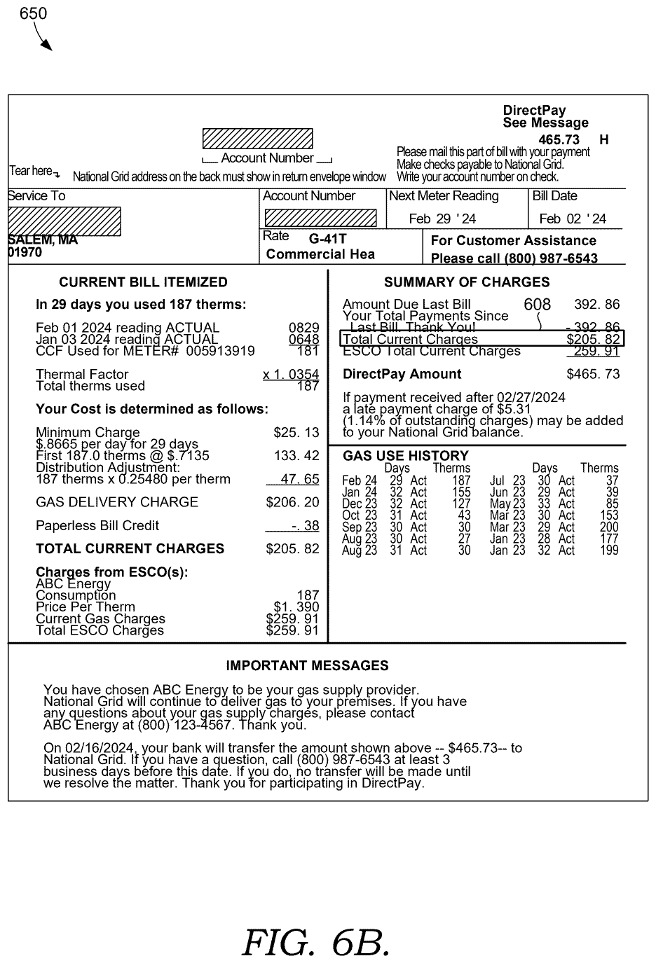

FIG. 6A is a screenshot of an example invoice 600 illustrating a historical document from which embodiments generate features and extract user behavior in order to make predictions with respect to a current invoice 650 of FIG. 6B, according to some embodiments. For example, the user behavior indicates that the user only pays $177.43 corresponding to the “Total Current Charges” field as indicated in 602. However, a base model, such as the base model 212 incorrectly predicts that the amount owed by the user is $392.86 corresponding to the “Direct Pay Amount” as indicated in 604 based on this amount being the highest amount. Various embodiments (e.g., the feature generation component 112 and the user behavior extraction component 106), however, creates features (e.g., extracts page number of the invoice 600, extracts quadrant ID of the $177.43 value, extracts words/number that are to the left, right, bottom, and top of the $177.43 value, and/or other spatial/contextual features. Various embodiments then populate these features into a feature store, such as storage 105, so that the next time an invoice is received (e.g., the invoice 650 of FIG. 6B) from the same vendor particular embodiments correctly predict that the amount paid amount corresponds to the “Total Current Changes” field, as opposed to the “Direct Pay Amount.”

FIG. 6B is a screenshot of an example invoice 650 illustrating how a particular value is predicted based on features and user behavior data extracted for the invoice 600 of FIG. 6A, according to some embodiments. Based on the user behavior that the user engaged in at the invoice 600 (i.e., that the user made a payment for the amount of $177.43) and the other contextual/spatial features of the invoice 600 (e.g., the words/numbers surrounding amount $177.43), various embodiments predict that the “Total Current Charges” value indicated in 606 (i.e., $205.82) is what the user should pay, instead of $465.73, as illustrated, for example with respect to the neural network 305 of FIG. 3. For example, various embodiments perform a KNN type of analysis to determine that the $205.82 value in invoice 650 is within a coordinate threshold (indicating the same or similar position) as the value $177.43 within invoice 600. Various embodiments also determine that these values are within the same quadrant. Various embodiments also determine that the words to the left of these values are the field “Total Current Charges,” and that the words below and above this field is “Last Bill, Thank you” and “ESCO Total Current Charges” in order to detect the amount due.

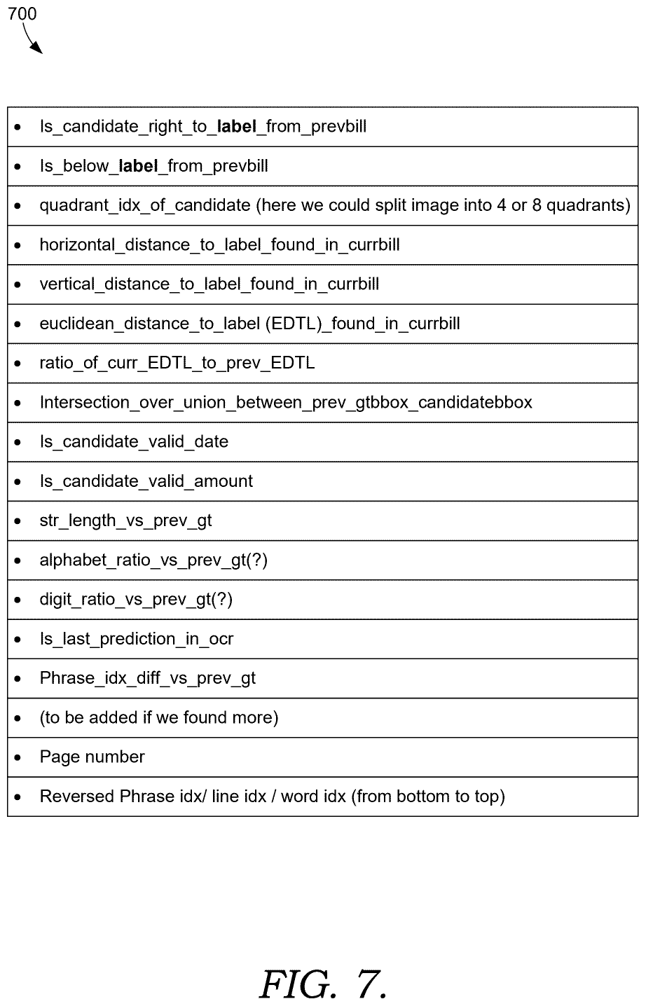

FIG. 7 is a schematic diagram of a table 700 representing different extracted features, according to some embodiments. In some embodiments, the table 700 represents the features generated by the feature generation component 112 and/or represents the feature generation 216 of FIG. 2, which is stored to the data store 218. In some embodiments, the table 700 represents a data structure, such as a lookup table, hash map, dictionary, or any other data structure that has key-value pairs, where the key column represents the feature type/attributes (as illustrated on the left side of the table 700) and the values represent the feature type values (as illustrated on the right side of the table 700). In some embodiments, the “features” as described herein represent the feature type/attributes themselves (e.g., “page number”). Alternatively or additionally, “features” represent the feature type values (e.g., “page 4”). A “candidate value” as described with respect to FIG. 7 refers to a candidate value or a value that is a candidate for prediction or extraction. Whereas a “label” refers to a particular field. For example, a candidate value may be “$2,000” which is directly under the label/field “Total Amount.”

As described in more detail below, many of the features indicated in the table 700 involve comparing candidate values extracted from a current bill (e.g., document 226) with the corresponding ground truth values extracted from previous documents (e.g., document 204). This comparison helps assess the consistency and accuracy of the extraction process over time. Some features evaluate the validity and quality of candidate values extracted from the document. For example, features like “Is_candidate_valid_date” and “Is_candidate_valid_amount” assess whether the extracted values for date and amount fields are in valid formats.

Several features quantify differences and relationships between candidate values and previous ground truth values. These differences may include measures such as distance, length, ratio, and index difference, providing insights into the variation and consistency of extracted values across documents. Features like “Page Number” and “Reversed Phrase idx/line idx, word idx (from bottom to top)” track the position of candidate values within the document, including the page number and the reversed index from bottom to top. This positional information helps contextualize the extracted values within the document layout.

Now referring to the specific features illustrated in the table 700, the “is_candidate_right_to_label_from_prevbill (previous bill)” feature indicates whether a candidate value in the current bill (e.g., document 222) is located to the right of a labeled field in the current bill that is also located in a previous bill (e.g., document 204). For example, If the value ($3, 500) in the current bill is to the right the “Total Amount Due” field in the current bill and there is also similarly another value from the previous bill that is located to the right of “Total Amount Due,” this feature would be True.

The “Is_below_label_from_prevbill” feature indicates feature indicates whether a candidate value in the current bill is located below a labeled field in the current bill that is also located in a previous bill. For example, If the value ($3, 500) in the current bill is blow the “Total Amount Due” field in the current bill and there is also similarly another value from the previous bill that is located below “Total Amount Due,” this feature would be True

The “quadrant_idx_of_candidate” feature assigns an index (and/or identifier (ID)) to the quadrant of the current bill where the candidate value is located. For example, if the candidate value is in the top-left quadrant of the image, the quadrant index would be 1. The “horizontal_distance_to_label_found_in_currbill (current bill)” indicates the horizontal distance between the candidate value in the current bill and the labeled field found in the same bill that is also located in a previous bill. For example, if the “Invoice Date” value of Nov. 16, 2024 is 50 pixels to the right of the “Invoice Date” field in the current bill, the horizontal distance would be 50 pixels.

The “vertical_distance_to_label_found_in_currbill” feature indicates a calculated vertical distance between the candidate value in the current bill and the labeled field found in the same bill that is also located in a previous bill. For example, if the “Due Date” value of Nov. 16, 2024 is 30 pixels below the “Due Date” field in the current bill, the vertical distance would be 30 pixels.

The “euclidian_distance_to_label_(EDTL)_found_in_currbill” feature indicates the Euclidean distance between the candidate value and the labeled field found in the current bill. For example, consider a value and label within a document with positions (x1, y1) and (x2, y2) respectively in a coordinate system. Euclidean Distance may then be represented as:

$$( x 2 - x 1 ) 2 + ( y 2 - y 1 ) 2 ( x 2 - x 1 ) 2 + ( y 2 - y 1 ) 2.$$

The “ratio_of_curr(current)_EDTL_to_prev_EDTL:” indicates the Euclidean distance between the candidate value and the labeled field in the current bill with the corresponding distance (e.g., the same label and another value) in the previous bill. For example, if the Euclidean distance between the candidate value and the labeled field in the current bill is 75 pixels and in the previous bill the Euclidian distance between another value and the labeled field was 50 pixels, the ratio would be 1.5.

The “intersection_over_union_between_prev_gtbox_candidatebbox” feature indicates the intersection over union (IoU) between the ground truth bounding box (representing ground truth value) in the previous document and the bounding box of the candidate value. For example, referring back to FIGS. 6A and 6B, if the IoU between two bounding boxes (one representing $177.43 in FIG. 6A and one representing $205.82) is 0.9, it indicates a high overlap between the candidate field and the ground truth, meaning that such values are indicative of the same “Total Current Charges” fields.

The “Is_candidate_valid_date” feature indicates whether the candidate value for a date field in the current bill is valid. Such valid determination may be based on conditional rules, such as incrementing a score towards validity upon detecting a forward slash, a dash, a certain quantity of characters before and/or after the forward slashes, the amount of forward slashes, or the like. For example, if the candidate value for the “Invoice Date” field in the current bill is a valid date format (e.g., YYYY-MM-DD), this feature would be True.

The “Is_candidate_valid_amount” feature indicates if the candidate value for an amount field in the current bill is valid. Such valid determination may be based on conditional rules, such as incrementing a score towards validity for a value if the value contains a dollar sign ($), has a decimal, etc. For example, if the candidate value for the “Total Amount Due” field in the current bill is a valid numerical amount (e.g., $100.00), this feature would be True.

The “Str_length_vs_prev_gt” feature indicates the length of the candidate string and the length of the corresponding string in the previous document representing the ground truth (and/or the distance/delta threof). For example, if the length of the candidate string for the “Vendor Name” field in the current bill is 10 characters and in the previous ground truth it was 12 characters, this feature might indicate a difference of −2.

The “alphabet_ratio_vs_prev_gt(?)” feature indicates a ratio of alphabetical characters in the candidate string of the current bill compared to the ground truth string indicated in the previous document. For example, if the candidate string for the “Vendor Name” field in the current bill contains 80% alphabet characters, while the previous ground truth string contained 75% alphabet characters, this feature might indicate an increase.

The “digit_ratio_vs_prev_gt(?):” feature indicates the ratio of digits (numeric characters) in the candidate string of the current bill compared to the ground truth indicated in the previous document. For example, if the candidate value for the “Invoice Number” field in the current bill contains 90% digits, while the previous ground truth string contained 85% digits, this feature might indicate an increase.

The “Is last Prediction in OCR” feature indicates whether the predicted value for the previous bill was in the text sequence generated from Optical Character Recognition (OCR). For example, if the candidate value for the “Total Amount Due” field was in the text sequence of the previous bill before processing the current bill, this feature would be True. The “Phrase_idx_diff_vs_prev_gt” feature indicates the difference in index (position) of the candidate value of the current bill compared to the previous ground truth value in the previous bill. For example, if the candidate value for the “Item Description” field in the current bill is located 2 positions ahead of the previous ground truth value indicated in the previous document, this feature would indicate a difference of +2.

The “Page Number” feature specifies the page number where the candidate value was found within the document. For example, if the candidate value for the “Due Date” field is located on page 2 of the document, this feature would indicate a page number of 2. The “Reversed Phrase idx/line idx, word idx (from bottom to top)” indicates the reversed index (position) of the candidate phrase, line, or word within the document, counting from bottom to top. For example, if the candidate value for the “Invoice Number” field is the second-to-last line on the page, this feature would provide a reversed line index of 2. All of these additional features capture various aspects of the candidate values extracted from the current bill and their relationships with previous ground truth values of previous documents, providing valuable information for evaluating the accuracy and consistency of the extraction process.

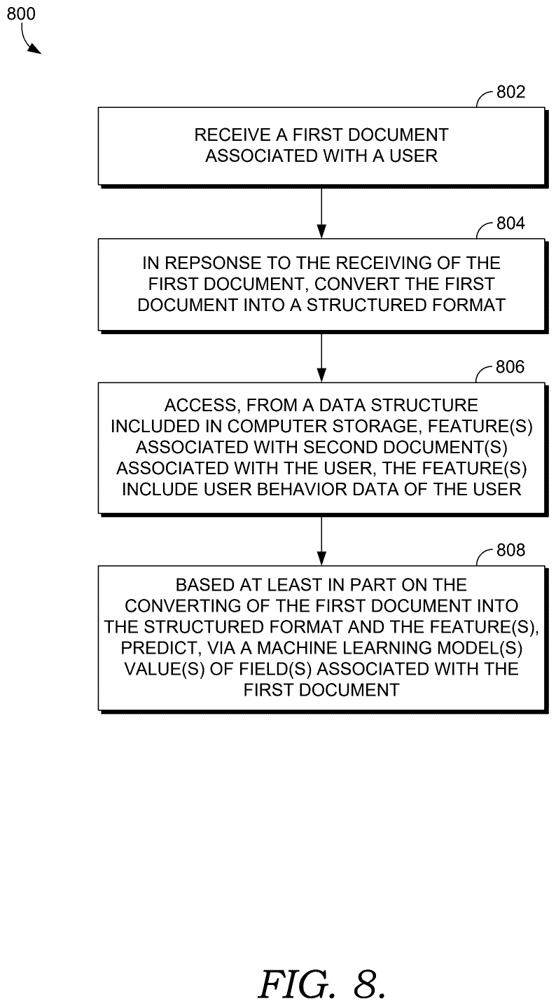

‘FIG. 8 is a flow diagram of an example process 800 for predicting one or more values of one or more fields associated with a document, according to some embodiments. The process 800 (and/or any of the functionality described herein) may be performed by processing logic that comprises hardware (e.g., AI hardware accelerator, circuitry, dedicated logic, programmable logic, microcode, etc.), software (e.g., instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein (e.g., as described with respect to FIG. 1 through FIG. 10). The computer-implemented method, the system (that includes at least one computing device having at least one processor and at least one computer readable storage medium), and/or the computer readable medium as described herein may perform or be caused to perform the process 1100 or any other functionality described herein.

Per block 802, some embodiments receive a first document associated with a user. For example, as illustrated by FIG. 2, the one or more server(s) 206 receive the document 204 that is uploaded by a user and received from the user device 202. In some embodiments, the first document and any document described herein is a financial document, such as an invoice, bill, a balance sheet (summary of balances of an entity or person), an income statement (indicates how revenue is transformed into net income or profit), a tax document, a cash flow statement (shows how changes in balance sheet accounts and income affect cash and cash equivalents), or a statement of changes in equity. Examples of invoices are described with respect to FIGS. 6A and 6B, as well as the invoice 500 of FIG. 5.

Prior to the receiving of the first document (e.g., document 222) some embodiments receive one or more second documents (e.g., document 204). In response to the receiving of the one or more second documents, some embodiments generate a user profile for the user. For example, as described in FIG. 2, the server(s) 206 generate the new vendor profile 208. In this way, the accessing of the one or more features at block 806 is further based on accessing the user profile, as illustrated, for example, in FIG. 2.

Per block 804, in response to the receiving of the first document, some embodiments convert the first document into a structured format. Examples of such conversion at block 804 is described with respect to the document processing component 104. For instance some embodiments perform Optical Character Recognition (OCR) at the first document to derive a structured version of the first document, such as a JSON file with parsed strings.

In response to converting the first document into the structured format at block 804, some embodiments encode the first document into the one or more feature vectors, as described, for example, with respect to the vectorization via the document processing component 104. In this way, the one or more feature vectors can be provided as input into a second machine learning model, such that the second machine learning model predicts one or more second values for one or more fields associated with the second based on the converting and the encoding (but not the one or more features/user behavior data). Examples of this are described with respect to the base model 212 (e.g., the second machine learning model) that predicts one or more values associated with the document 204. Examples of such prediction are described with respect to the based information extraction model 108 of FIG. 8. The second machine learning model is included in the one or more machine learning models of the process 800 in some embodiments.

Some embodiments further determine that the one or more second values (predicted by the second machine learning model) fall outside of a correctness threshold. Examples of this are described with respect to the decision block 214 of FIG. 2. In response to the determining that the one or more second values fall outside of the correctness threshold, some embodiments then extract, from the one or more second documents, one or more features (which are the same features that are accessed at block 806). Examples of this are described with respect to the feature generation 216 of FIG. 2, the feature generation component 112 of FIG. 1, and/or the features within the table 700 of FIG. 7.

Per block 806, some embodiments access, from a data structure (e.g., a lookup data structure or database) included in computer storage (e.g., RAM, cache, or disk), one or more features (e.g., based at least in part on the one or more feature vectors or at least partially responsive to the receiving of the first document) associated with the one or more second documents associated with the user, where the one or more features include user behavior data of the user. For example, with respect to FIG. 7, some embodiments access the table 700 and/or user behavior (e.g., as extracted by the user behavior extraction component 106) that the user recorded the “amount payable” field as being a particular value, both of which are then recorded as being the ground truth.

In response to the converting of the first document into the structured format at block 804, some embodiments encode (e.g., convert) the first document into one or more feature vectors. In response to the encoding, some embodiments then determine a distance (e.g., a Euclidian distance) between the one or more feature vectors and one or more other feature vectors representing the one or more second documents. Euclidean distance measures the straight-line distance between two points in the feature space and provides a measure of similarity or dissimilarity between documents. Some embodiments apply the KNN algorithm to find the k-nearest neighbors of the current first document among the historical documents (e.g., the second one or more documents). KNN is a simple, non-parametric algorithm used for classification and regression tasks based on the similarity of data points. In this context, KNN can be used to identify the historical documents that are most similar to the current user document based on their Euclidean distances in the feature space.

Based at least in part on the distance, some embodiments then determine that the first document was uploaded by the user, wherein the prediction of the one or more first values is based at least in part on the determining that the first document was uploaded by the user. For example, once the k-nearest neighbors are identified, if the documents are labeled with categories or classes (e.g., user identifier, invoice types, document categories), the majority class among the nearest neighbors could be assigned to the current document. For example, vectors representing the first document may be closest to a second document labeled as a particular vendor (based on the document's features) and so the first document may then be associated with the particular vendor based on the vectorization and labeling of historical documents.

In some embodiments, the one or more features accessed at block 806 include any suitable feature or combination thereof, such as a quadrant identifier that a candidate value is in at the first document (e.g., ““quadrant_idx_of_candidate,” a distance or position that the candidate value is relative a first field (e.g., “is_candidate_right_to_label_from_prevbill (previous bill),” Is_below_label_from_prevbill,” “vertical_distance_to_label_found_in_currbill,” “euclidian_distance_to_label_(EDTL)_found_in_currbill,” “horizontal_distance_to_label_found_in_currbill,” “euclidian_distance_to_label_(EDTL)_found_in_currbill”) an intersection over union (IoU) between a ground truth bounding box representing a ground truth value in the one or more second documents and abounding box of the candidate value (e.g., “intersection_over_union_between_prev_gtbox_candidatebbox”), an indication of whether the candidate value for a date field in the current bill is valid (e.g., “Is_candidate_valid_date,”), an indication of whether the candidate value for an amount field in the current bill is valid (“Is_candidate_valid_amount,”), a length of a candidate string of the candidate value and a length of a corresponding string in the one or more second documents representing the ground truth (e.g., “Str_length_vs_prev_gt,” a ratio of numeric characters in the candidate string of the first document compared to the ground truth indicated in the one or more second documents (e.g., “digit_ratio_vs_prev_gt(?),” and a page number of the first document (which may be compared to a page number of the one or more second documents to predict values; e.g., if values between first and second documents are on the same page 2, then values most likely belong to a particular field). The “user behavior data” may be what values are determined to be “ground truth” values. For example, a user may have selected date A to pay a total amount on, and so date A would be the ground truth value for payment.

Per block 808, based at least in part on the converting of the first document into the structured format and/or the one or more features, some embodiments predict (e.g., classify, via a classifier layer of a neural network), via one or more machine learning models one or more values of one or more fields (and/or entities) associated with the first document. In some embodiments, block 808 need not be positively performed, but rather some embodiments, for example, convert the one or more features into numerical representations (e.g., additional feature vectors or soft prompts) and then provide the numerical representations as input into a first machine learning model (e.g., transmit a signal over a network that causes/instructs a model perform predictions), where the first machine learning model predicts the one or more first values for the one or more fields associated with the first document based at least in part on the user behavior data. In some embodiments such “field(s)” at block 808 includes fields located in the first document itself. Alternatively or additionally, such field(s) at block 808 includes fields located in accounting software or other page (e.g., an HTML) that is not the first or second document. In these embodiments, an accounting software page, for example, may contain similar (but not identical) fields relative to the first document that are used to make a payment. For example, a “amount to be paid” field on an accounting software page may be equivalent to the “total amount” field on the first document

FIG. 9 is a block diagram of a computing environment 900 in which aspects of the present disclosure are employed in, according to certain embodiments. Although the environment 900 illustrates specific components at a specific quantity, it is recognized that more or less components may be included in the computing environment 900. For example, in some embodiments, there are multiple user devices 902 and multiple servers 904, such as nodes in a cloud or distributing computing environment. In some embodiments, some or each of the components of the system 100 of FIG. 1 are hosted in the one or more servers 904. In some embodiments, the user device(s) 902 and/or the server(s) 904 may be embodied in any physical hardware, such as the computing device 1000 of FIG. 10.

The one or more user devices 902 are communicatively coupled to the server(s) 904 via the one or more networks 110. In practice, the connection may be any viable data transport network, such as, for example, a LAN or WAN. Network(s) 110 can be for example, a local area network (LAN), a wide area network (WAN) such as the Internet, or a combination of the two, and include wired, wireless, or fiber optic connections. In general, network(s) 110 can be any combination of connections and protocols that will support communications between the control server(s) 904 and the user devices 902.

In some embodiments, a user issues a query on the one or more user devices 902, after which the user device(s) 902 communicate, via the network(s) 110, to the one or more servers 904 and the one or more servers 904 executes the query (e.g., via one or more components of FIG. 1) and causes or provides for display information back to the user device(s) 902. For example, the user may issue a query at the user device 902 that is indicative of an upload request to process a document to extract or predict fields. Responsively, the server(s) 904 can perform functionality as described with respect to FIG. 1.

The invention may be described in the general context of computer code or machine-useable instructions, including computer-executable instructions such as program modules, being executed by a computer (or one or more processors) or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 10, computing device 15 includes bus 10 that directly or indirectly couples the following devices: memory 12, one or more processors 14, one or more presentation components 16, input/output (I/O) ports 18, input/output components 20, and illustrative power supply 22. Bus 10 represents what may be one or more busses (such as an address bus, data bus, or combination thereof). Although the various blocks of FIG. 15 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that this diagram is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 10 and reference to “computing device.”

In some embodiments, the computing device 15 represents the physical embodiments of one or more systems and/or components described above. For example, the computing device 15 can represent: the one or more user devices 902, and/or the server(s) 904 of FIG. 9. The computing device 15 can also perform some or each of the blocks in the process 800 and/or any functionality described herein with respect to FIGS. 1-10. It is understood that the computing device 15 is not to be construed necessarily as a generic computer that performs generic functions. Rather, the computing device 15 in some embodiments is a particular machine or special-purpose computer. For example, in some embodiments, the computing device 15 is or includes: a multi-user mainframe computer system, one or more cloud computing nodes, a single-user system, or a server computer or similar device that has little or no direct user interface, but receives requests from other computer systems (clients), a desktop computer, portable computer, laptop or notebook computer, tablet computer, pocket computer, telephone, smart phone, smart watch, or any other suitable type of electronic device.

Computing device 15 typically includes a variety of computer-readable media. Computer-readable media can be any available media that can be accessed by computing device 15 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 15. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 12 includes computer storage media in the form of volatile and/or nonvolatile memory. The memory may be removable, non-removable, or a combination thereof. Exemplary hardware devices include solid-state memory, hard drives, optical-disc drives, etc. Computing device 15 includes one or more processors 14 that read data from various entities such as memory 12 or I/O components 20. Presentation component(s) 16 present data indications to a user or other device. Exemplary presentation components include a display device, speaker, printing component, vibrating component, etc.

I/O ports 18 allow computing device 15 to be logically coupled to other devices including I/O components 20, some of which may be built in. Illustrative components include a microphone, joystick, game pad, satellite dish, scanner, printer, wireless device, etc. The I/O components 20 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 15. The computing device 15 may be equipped with depth cameras, such as, stereoscopic camera systems, infrared camera systems, RGB camera systems, and combinations of these for gesture detection and recognition. Additionally, the computing device 1500 may be equipped with accelerometers or gyroscopes that enable detection of motion.

As described above, implementations of the present disclosure relate to automatically generating a user interface or rendering one or more applications based on contextual data received about a particular user. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub combinations are of utility and may be employed without reference to other features and sub combinations. This is contemplated by and is within the scope of the claims.

### Definitions

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” or “component” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

The terms first (e.g., first cache), second (e.g., second cache), etc. are not to be construed as denoting or implying order or time sequences unless expressly indicated otherwise. Rather, they are to be construed as distinguishing two or more elements. In some embodiments, the two or more elements, although distinguishable, have the same makeup. For example, a first memory and a second memory may indeed be two separate memories but they both may be RAM devices that have the same storage capacity (e.g., 4 GB).

The term “causing” or “cause” means that one or more systems (e.g., computing devices) and/or components (e.g., processors) may in in isolation or in combination with other systems and/or components bring about or help bring about a particular result or effect. For example, a server computing device may “cause” a message to be displayed to a user device (e.g., via transmitting a message to the user device) and/or the same user device may “cause” the same message to be displayed (e.g., via a processor that executes instructions and data in a display memory of the user device). Accordingly, one or both systems may in isolation or together “cause” the effect of displaying a message.

What is claimed is:

1. A computerized system comprising:
one or more processors; and
computer storage memory having computer-executable instructions stored thereon which, when executed by the one or more processors, implement operations comprising:
receiving a first document associated with a user;
encoding the first document into one or more feature vectors;
based at least in part on the one or more feature vectors, accessing, from a data structure included in computer storage, one or more features associated with one or more second documents, the one or more features including user behavior data associated with the user and the one or more second documents;
converting the one or more features into numerical representations; and
providing the numerical representations as input into a first machine learning model, wherein the machine learning model predicts one or more first values for one or more fields associated with the first document based at least in part on the user behavior data.

2. The system of claim 1, wherein the operations further comprising:
receiving, prior to the receiving of the first document, the one or more second documents; and
in response to the receiving of the one or more second documents, generating a user profile for the user, and wherein the accessing of the one or more features is further based on accessing the user profile.

3. The system of claim 1, wherein the operations further comprising:
in response to converting the first document into the structured format, performing the encoding of the first document into the one or more feature vectors; and
providing the one or more feature vectors as input into a second machine learning model, wherein the second machine learning model predicts one or more second values for one or more fields associated with the one or more second documents based on the converting and the encoding but not the one or more features.

4. The system of claim 3, wherein the operations further comprising:
determining that the one or more second values fall outside of a correctness threshold; and
in response to the determining that the one or more second values fall outside of the correctness threshold, extract, from the one or more second documents, at least a portion of the one or more features.

5. The system of claim 1, wherein the operations further comprising:
in response to converting the first document into a structured format, performing the encoding of the first document into the one or more feature vectors;
in response to the encoding, determining a distance between the one or more feature vectors and one or more other feature vectors representing the one or more second documents; and
based at least in part on the distance, determining that the first document was uploaded by the user, wherein the prediction of the one or more first values is based at least in part on the determining that the first document was uploaded by the user.

6. The system of claim 1, wherein the one or more features include at least one of: a quadrant identifier that a candidate value is in at the first document, a distance or location that the candidate value is in relative to a first field, an intersection over union (IoU) between a ground truth bounding box representing a ground truth value in the one or more second documents and a bounding box of the candidate value, an indication of whether the candidate value for a date field in the current bill is valid, an indication of whether the candidate value for an amount field in the current bill is valid, a length of a candidate string of the candidate value and a length of a corresponding string in the one or more second documents representing the ground truth, a ratio of numeric characters in the candidate string of the first document compared to the ground truth indicated in the one or more second documents, and a page number of the first document.

7. The system of claim 1, wherein the first machine learning model is a Large Language Model (LLM), and wherein the input includes a prompt, and wherein the prompt includes at least two of, user selections from past bills, an Optical Character Recognition (OCR)-generated structure of the first document, the user behavior data, a 1-shot or few-shot example, or a request to generate a set of values for a set of fields.

8. The system of claim 1, wherein the operations further comprising:
receiving user feedback indicative of a degree of correctness of the prediction; and
providing the user feedback as input into the first machine learning model, and wherein the first machine learning model generates a second prediction based at least in part on the user feedback.

9. The system of claim 1, wherein the first document and the one or more second documents are one of: a set of invoices, a set of bills, a set of balance sheets, a set of income statements, a set of tax documents, a set of cash flow statements, or a set of statement of changes in equity.

10. A computer-implemented method comprising:
receiving a first document associated with a user;
in response to the receiving of the first document, converting the first document into a structured format;
accessing, from a data structure included in computer storage, one or more features associated with one or more second documents associated with the user, the one or more features include user behavior data of the user; and
based at least in part on the converting of the first document into the structured format and the one or more features, predicting, via one or more machine learning models, one or more values of one or more fields associated with the first document.

11. The computer-implemented method of claim 10, further comprising:
receiving, prior to the receiving of the first document, the one or more second documents; and
in response to the receiving of the one or more second documents, generating a user profile for the user, and wherein the accessing of the one or more features is further based on accessing the user profile.

12. The computer-implemented method of claim 10, further comprising:
encoding the first document into one or more feature vectors; and
providing the one or more feature vectors as input into a second machine learning model, wherein the second machine learning model predicts one or more second values for one or more fields associated with the one or more second documents based on the encoding but not the one or more features.

13. The computer-implemented method of claim 12, further comprising:
determining that the one or more second values fall outside of a correctness threshold; and
in response to the determining that the one or more second values fall outside of the correctness threshold, extract, from the one or more second documents, at least a portion of the one or more features.

14. The computer-implemented method of claim 10, further comprising:
in response to converting the first document into the structured format, encoding the first document into one or more feature vectors;
in response to the encoding, determining a distance between the one or more feature vectors and one or more other feature vectors representing the one or more second documents; and
based at least in part on the distance, determining that the first document was uploaded by the user, wherein the prediction of the one or more values is based at least in part on the determining that the first document was uploaded by the user.

15. The computer-implemented method of claim 10, wherein the one or more features include at least one of: a quadrant identifier that a candidate value is in at the first document, a distance or location that the candidate value is in relative to a first field, an intersection over union (IoU) between a ground truth bounding box representing a ground truth value in the one or more second documents and a bounding box of the candidate value, an indication of whether the candidate value for a date field in the current bill is valid, an indication of whether the candidate value for an amount field in the current bill is valid, a length of a candidate string of the candidate value and a length of a corresponding string in the one or more second documents representing the ground truth, a ratio of numeric characters in the candidate string of the first document compared to the ground truth indicated in the one or more second documents, and a page number of the first document.

16. The computer-implemented method of claim 10, wherein the first machine learning model is a Large Language Model (LLM), and wherein the input includes a prompt, and wherein the prompt includes at least two of, user selections from past bills, an Optical Character Recognition (OCR)-generated structure of the first document, the user behavior data, a 1-shot or few-shot example, or a request to generate a set of values for a set of fields.

17. The computer-implemented method of claim 10, further comprising:
receiving user feedback indicative of a degree of correctness of the prediction; and
providing the user feedback as input into the first machine learning model, and wherein the first machine learning model generates a second prediction based at least in part on the user feedback.

18. The computer-implemented method of claim 10, wherein the first document and the one or more second documents are one of: a set of invoices, a set of bills, a set of balance sheets, a set of income statements, a set of tax documents, a set of cash flow statements, or a set of statement of changes in equity.

19. One or more computer storage media having computer-executable instructions embodied thereon that, when executed, by one or more processors, cause the one or more processors to perform a method, the method comprising:
receiving a first document uploaded by a user;
at least partially responsive to the receiving of the first document, accessing, from a data structure included in computer storage, one or more features associated one or more second documents uploaded by the user prior to the receiving of the first document uploaded by the user; and
based at least in part on at least in part on the one or more features, determining one or more values for one or more entities associated with the first document.

20. The one or more computer storage media of claim 19, wherein the determining is based on using a first machine learning model, and wherein the first machine learning model is a Large Language Model (LLM), and wherein an input includes a prompt, and wherein the prompt includes at least two of, user selections from past bills, an Optical Character Recognition (OCR)-generated structure of the first document, user behavior data, a 1-shot or few-shot example, or a request to generate a set of values for a set of fields.
